(19) United States
(12) Patent Application Publication
(10) Pub. No.: US 2023/0088955 A1
(43) Pub. Date: Mar. 23, 2023

(54) METHOD FOR DISPLAYING STATUS OF PDU SESSION THAT IS DEACTIVATED OR ESTABLISHED ACCORDING TO AF REQUEST ON SCREEN

(71) Applicant: LG Electronics Inc., Seoul (KR)

(72) Inventor: Hyunsook KIM, Seoul (KR)

(21) Appl. No.: 17/909,079

(22) PCT Filed: Oct. 6, 2020
(86) PCT No.: PCT/KR2020/013570

§ 371 Date: Sep. 2, 2022

(30) Foreign Application Priority Data
Mar. 2, 2020 (KR) 10-2020-0026170

(51) Int. Cl. H04W 60/04; H04W 76/19; H04W 76/30

(52) U.S. Cl. CPC H04W 60/04; H04W 76/19; H04W 76/30

(57) ABSTRACT

A disclosure of the present specification provides a screen display method by a user equipment (UE). The method may comprise the steps of displaying, on a screen, information indicating that a protocol data unit (PDU) session is scheduled to be re-established, on the basis of a deactivation procedure or a release procedure of the PDU session having been performed; and when the PDU session is established, displaying, on the screen, information indicating the existence of the PDU session.

### TECHNICAL FIELD

The present specification relates to mobile communications.

### BACKGROUND

FIG. 1 is a structural diagram of an evolved mobile communication network.

The Evolved Packet Core (EPC) may include various components, and in FIG. 1, some of them, a Serving Gateway (S-GW) 52, a Packet Data Network Gateway (PDN GW) 53, Mobility Management Entity (MME) 51, Serving General Packet Radio Service (GPRS) Supporting Node (SGSN), enhanced Packet Data Gateway (ePDN) are shown.

The S-GW 52 is an element that functions as a boundary point between the Radio Access Network (RAN) and the core network, and maintains a data path between the eNodeB 22 and the PDN GW 53. In addition, when a terminal (or User Equipment: UE) moves over an area served by the eNodeB 22, the S-GW 52 serves as a local mobility anchor point. That is, packets may be routed through the S-GW 52 for mobility within the E-UTRAN (Evolved Universal Mobile Telecommunications System (UTMS) Terrestrial Radio Access Network defined after 3GPP Release-8). In addition, the S-GW 52 may serve as an anchor point for mobility with other 3GPP networks (RAN defined before 3GPP Release-8, e.g., UTRAN or Global System for Mobile Communication (GSM)/Enhanced Data rates for Global Evolution (EDGE) Radio Access Network (GERAN)).

The PDN GW (or P-GW) 53 corresponds to the termination point of the data interface towards the packet data network. The PDN GW 53 may support policy enforcement features, packet filtering, charging support, and the like. In addition, the PDN GW 53 may serve as an anchor point for mobility management between the 3GPP network and the non-3GPP network (e.g., untrusted networks such as Interworking Wireless local area networks (I-WLANs), trusted networks such as Code Division Multiple Access (CDMA) networks).

In the example of the network structure of FIG. 1, the S-GW 52 and the PDN GW 53 are configured as separate gateways, but the two gateways may be implemented according to a single gateway configuration option.

The MME 51 is an element that performs signaling and control functions to support access to a network connection of the UE, allocation of network resources, tracking, paging, roaming and handover, etc. The MME 51 controls control plane functions related to subscriber and session management. The MME 51 manages a number of eNodeBs 22 and performs signaling for selection of a conventional gateway for handover to another 2G/3G network. In addition, the MME 51 performs functions such as security procedures, terminal-to-network session handling, and idle terminal location management.

The SGSN handles all packet data such as user's mobility management and authentication to other access3GPP networks (e.g., GPRS networks, UTRAN/GERAN).

The ePDG acts as a security node for untrusted non-3GPP networks (e.g., I-WLAN, Wi-Fi hotspots, etc.).

As described with reference to FIG. 1, the terminal (or UE) having IP capability may access an IP service network (e.g., IMS) provided by the operator via various elements in the EPC based on 3GPP access as well as non-3GPP access.

In addition, FIG. 1 shows various reference points (e.g., S1-U, S1-MME, etc). In the 3GPP system, a conceptual link connecting two functions existing in different functional entities of E-UTRAN and EPC is defined as a reference point. Table 1 below summarizes the reference points shown in FIG. 1. In addition to the examples in Table 1, various reference points may exist according to the network structure.

TABLE 1

| Reference | |
|---|---|
| points | Description |
| S1-MME | Reference point for control plane protocol between E-UTRAN and MME |
| S1-U | Reference point between E-UTRAN and SGW for inter-eNB path |
| | switching and per-bearer user plane tunneling during handover |
| S3 | Reference point between MME and SGSN providing user and bearer |
| | information exchange for mobility between 3GPP access networks in idle |
| | and/or active state. This reference point may be used for intra-Public Land |
| | Mobile Network (PLMN) or inter-PLMN (e.g., in case of inter-PLMN |
| | handover). |
| S4 | Reference point between the SGW and SGSN providing related control |
| | and mobility support between the GPRS core and the 3GPP anchor |
| | function of the SGW. In addition, if a direct tunnel is not established, user |
| | plane tunneling is provided. |
| S5 | Reference point providing user plane tunneling and tunnel management |
| | between SGW and PDN GW. Used for SGW relocation when connection |
| | to a PDN GW not co-located with the SGW is required due to UE |
| | mobility and for the required PDN connectivity |
| S11 | Reference point between MME and SGW |
| SGi | Reference point between PDN GW and PDN. The PDN may be a public |
| | or private PDN external to the operator or an intra-operator PDN for e.g., |
| | provision of an IMS service. This reference point corresponds to Gi of |
| | 3GPP access. |

Among the reference points shown in FIG. 1, S2a and S2b correspond to non-3GPP interfaces. S2a is a reference point that provides related control and mobility support between trusted non-3GPP access and PDN GWs to the user plane. S2b is a reference point that provides related control and mobility support between ePDG and PDN GW to the user plane.

With the success of Long-Term Evolution (LTE)/LTE-Advanced (LTE-A) for the fourth-generation mobile communication, the next generation mobile communication, which is the fifth-generation (so called 5G) mobile communication, has been attracting attentions and more and more researches are being conducted.

The fifth-generation communication defined by the International Telecommunication Union (ITU) refers to providing a maximum data transmission speed of 20 Gbps and a maximum transmission speed of 100 Mbps per user in anywhere. It is officially called “IMT-2020” and aims to be released around the world in 2020.

The fifth-generation mobile communication supports multiples numerologies (and/or multiple Subcarrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

NR frequency band is defined as a frequency range of two types, i.e., FR1, FR2. FR1 is 410 MHz-7125 MHz, and FR2 is 24250 MHz-52600 MHz, meaning millimeter wave (mmW).

For convenience of explanation, among the frequency ranges used in the NR system, FR1 may mean “sub 6 GHz range”. FR2 may mean “above 6 GHz range”, and may be referred to as millimeter Wave (mmW).

TABLE 2

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system can be changed. For example, FR1 may include a band of 410 MHz to 7125 MHz as shown in Table 2 below. That is, FR1 may include a frequency band of above 6 GHz (or, 5850, 5900, 5925 MHz, etc.). For example, a frequency band of above 6 GHz (or, 5850, 5900, 5925 MHz, etc.) included in FR1 may include an unlicensed band. The unlicensed band may be used for various purposes, e.g., for communication for a vehicle (e.g., autonomous driving).

TABLE 3

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

The ITU suggests three usage scenarios, e.g., enhanced Mobile Broadband (eMBB), massive Machine Type Communication (mMTC), and Ultra-Reliable and Low Latency Communications (URLLC).

URLLC relates to a usage scenario in which high reliability and low delay time are required. For example, services like autonomous driving, automation, and virtual realities requires high reliability and low delay time (e.g., 1 ms or less). A delay time of the current 4G (LTE) is statistically 21-43 ms (best 10%), 33-75 ms (median). Thus, the current 4G (LTE) is not sufficient to support a service requiring a delay time of 1 ms or less.

Next, the eMBB relates to a usage scenario that requires a mobile ultra-wideband.

These ultra-wideband high-speed services seem to be difficult to accommodate by existing core networks designed for LTE/LTE-A.

Therefore, the redesign of core networks is urgently needed in so-called fifth-generation mobile communications.

FIG. 2 is a structural diagram of a next-generation mobile communication network.

The 5G Core network (5GC) may include various components, part of which are shown in FIG. 2, including an Access and mobility Management Function (AMF) 41, a Session Management Function (SMF) 42, a Policy Control Function (PCF) 43, a User Plane Function (UPF) 44, an Application Function (AF) 45, a Unified Data Management (UDM) 46 and a Non-3GPP Interworking Function (N3IWF) 49.

A UE 10 is connected to a data network via the UPF 44 through a Next Generation Radio Access Network (NG-RAN) (i.e., gNB or base station).

The UE 10 may be provided with a data service even through untrusted non-3GPP access, e.g., a Wireless Local Area Network (WLAN). In order to connect the non-3GPP access to a core network, the N3IWF 59 may be deployed.

FIG. 3 is an exemplary diagram illustrating a predicted structure of a next generation mobile communication in terms of a node.

Referring to FIG. 3, the UE is connected to a Data Network (DN) through a NG-RAN.

The Control Plane Function (CPF) node as shown may perform all or part of the Mobility Management Entity (MME) function of the fourth generation mobile communication, and all or a part of the control plane function of the Serving Gateway (S-GW) and the PDN-Gateway (P-GW) of the fourth generation mobile communication. The CPF node includes an Access and mobility Management Function (AMF) node and a Session Management Function (SMF).

The User Plane Function (UPF) node as shown is a type of a gateway over which user data is transmitted and received. The UPF node may perform all or part of the user plane functions of the S-GW and the P-GW of the fourth generation mobile communication.

The Policy Control Function (PCF) node as shown is configured to control a policy of the service provider.

The Application Function (AF) node as shown refers to a server for providing various services to the UE.

The Unified Data Management (UDM) node as shown refers to a type of a server that manages subscriber information, such as a Home Subscriber Server (HSS) of 4th generation mobile communication. The UDM node stores and manages the subscriber information in the Unified Data Repository (UDR).

The Authentication Server Function (AUSF) node as shown authenticates and manages the UE.

The Network Slice Selection Function (NSSF) node as shown refers to anode for performing network slicing as described below.

In FIG. 3, a UE can simultaneously access two data networks using multiple Protocol Data Unit (PDU) sessions.

FIG. 4 is an exemplary diagram illustrating an architecture for supporting simultaneously access two data networks.

FIG. 4 illustrates an architecture that allows the UE to simultaneously access two data networks using one PDU session.

Reference points shown in FIGS. 3 and 4 are as follows.

N1 is a reference point between UE and AMF.

N2 is a reference point between (R)AN and AMF.

N3 is a reference point between (R)AN and UPF.

N4 is a reference point between SMF and UPF.

N5 is a reference point between PCF and AF.

N6 is a reference point between UPF and DN.

N7 is a reference point between SMF and PCF.

N8 is a reference point between UDM and AMF.

N9 is a reference point between UPFs.

N10 is a reference point between UDM and SMF.

N11 is a reference point between AMF and SMF.

N12 is a reference point between AMF and AUSF.

N13 is a reference point between UDM and AUSF.

N14 is a reference point between AMFs.

N15 is a reference point between PCF and AMF.

N16 is a reference point between SMFs.

N22 is a reference point between AMF and NSSF.

FIG. 5 is another exemplary diagram showing a structure of a radio interface protocol between a UE and a gNB.

The radio interface protocol is based on the 3GPP radio access network standard. The radio interface protocol is horizontally composed of a physical layer, a data link layer, and a network layer, and is vertically divided into a user plane for transmission of data information and a control plane for transfer of control signal (signaling).

The protocol layers may be divided into L1 (first layer), L2 (second layer), and L3 layer (third layer) based on the lower three layers of the Open System Interconnection (OSI) reference model widely known in communication systems.

Hereinafter, each layer of the radio protocol will be described.

The first layer, the physical layer, provides an information transfer service using a physical channel. The physical layer is connected to an upper medium access control layer through a transport channel, and data between the medium access control layer and the physical layer is transmitted through the transport channel. In addition, data is transmitted between different physical layers, that is, between the physical layers of a transmitting side and a receiving side through a physical channel.

The second layer includes a Medium Access Control (MAC) layer, a Radio Link Control (RLC) layer, and a Packet Data Convergence Protocol (PDCP) layer.

The third layer includes Radio Resource Control (hereinafter abbreviated as RRC) layer. The RRC layer is defined only in the control plane and is in charge of control of logical channels, transport channels, and physical channels related to configuration, reconfiguration and release of radio bearers. In this case, RB refers to a service provided by the second layer for data transfer between the UE and the E-UTRAN.

The Non-Access Stratum (NAS) layer performs functions such as connection management (session management) and mobility management.

The NAS layer is divided into a NAS entity for Mobility Management (MM) and a NAS entity for Session Management (SM).

1) NAS entity for MM provides the following functions in general.

NAS procedures related to AMF include the following.
Registration management and access management procedures. AMF supports the following functions.
Secure NAS signal connection between UE and AMF (integrity protection, encryption)

2) The NAS entity for SM performs session management between the UE and the SMF.

The SM signaling message is processed, that is, generated and processed, at an NAS-SM layer of the UE and SMF. The contents of the SM signaling message are not interpreted by the AMF.
In the case of SM signaling transmission,
The NAS entity for the MM creates a NAS-MM message that derives how and where to deliver an SM signaling message through a security header representing the NAS transmission of SM signaling and additional information on a received NAS-MM.
Upon receiving SM signaling, the NAS entity for the SM performs an integrity check of the NAS-MM message, analyzes additional information, and derives a method and place to derive the SM signaling message.

Meanwhile, in FIG. 5, the RRC layer, the RLC layer, the MAC layer, and the PHY layer located below the NAS layer are collectively referred to as an Access Stratum (AS).

A network system (i.e., 5GC) for next-generation mobile communication (i.e., 5G) also supports non-3GPP access. An example of the non-3GPP access is typically a WLAN access. The WLAN access may include both a trusted WLAN and an untrusted WLAN.

In the system for 5G, AMF performs Registration Management (RM) and Connection Management (CM) for 3GPP access as well as non-3GPP access.

On the other hand, when the UE creates a PDU session in 3GPP access or non-3GPP access and then attempts to perform handover to another access, the handover may fail if resource reservation in the access network fails.

In this case, the SMF is supposed to notify the AMF that the PDU session has been released. In this case, AMF deletes all contexts for the corresponding PDU session. In this case, there is a problem in that the UE can no longer send and receive NAS signaling for the PDU session.

### SUMMARY

Accordingly, an object of the present specification is to propose a method for solving the above-described problems.

In order to solve the above-described problems, a disclosure of the present specification provides a method for displaying a screen by a User Equipment (UE). The method may comprise, based on a deactivation procedure or a release procedure of a Protocol Data Unit (PDU) session being performed, displaying information informing that a PDU session is scheduled to be established again on a screen; and when the PDU session is established, displaying information informing an existence of the PDU session on a screen.

The method may further comprise displaying information informing of release on a screen, when the established PDU session is released.

The method may further comprise stopping displaying the information informing the existence of the PDU session, when the established PDU session is released.

The information informing that the PDU session is scheduled to be established again may be displayed in a notification window.

The information informing the existence of the PDU session may be displayed by an indicator.

The method may further comprise performing the deactivation procedure or the release procedure of the PDU session.

The method may further comprise performing an establishment procedure of the PDU session.

In order to solve the above-described problems, a disclosure of the present specification provides a chipset mounted on a User Equipment (UE). The chipset may comprise at least one processor; at least one memory for storing instructions and operably electrically connectable to the at least one processor. The instructions, based on being executed by the at least one processor, may perform operations comprising: based on a deactivation procedure or a release procedure of a Protocol Data Unit (PDU) session being performed, displaying information informing that a PDU session is scheduled to be established again on a screen; and when the PDU session is established, displaying information informing an existence of the PDU session on a screen.

In order to solve the above-described problems, a disclosure of the present specification provides a User Equipment (UE). The UE may comprise a transceiver; at least one processor; and at least one memory for storing instructions and operably electrically connectable to the at least one processor. The instructions, based on being executed by the at least one processor, may perform operations comprising: based on a deactivation procedure or a release procedure of a Protocol Data Unit (PDU) session being performed, displaying information informing that a PDU session is scheduled to be established again on a screen; and when the PDU session is established, displaying information informing an existence of the PDU session on a screen.

In order to solve the above-described problems, a disclosure of the present specification provides a non-volatile computer-readable storage medium having recorded thereon instructions. The instructions, when executed by one or more processors mounted on a User Equipment (UE), may cause the one or more processors to perform operation comprising: based on a deactivation procedure or a release procedure of a Protocol Data Unit (PDU) session being performed, displaying information informing that a PDU session is scheduled to be established again on a screen; and when the PDU session is established, displaying information informing an existence of the PDU session on a screen.

According to the disclosure of the present specification, it is possible to solve the problems of the prior art.

According to the disclosure of the present specification, it is possible to increase the Quality of Experience (QoE) and quality of a Mobile Edge Computing (MEC) service based on a request from a third party.

In addition, according to the disclosure of the present specification, MEC service can be provided even in a limited network topology environment, and MEC service conforming to a third party's security/policy, etc., can be provided regardless of the network topology, thereby increasing the flexibility of MEC service provision.

### BRIEF DESCRIPTION OF THE DRAWINGS

FIG. 1 is a structural diagram of an evolved mobile communication network.

FIG. 2 is a structural diagram of a next-generation mobile communication network.

FIG. 3 is an exemplary diagram illustrating a predicted structure of a next generation mobile communication in terms of a node.

FIG. 4 is an exemplary diagram illustrating an architecture for supporting simultaneously access two data networks.

FIG. 5 is another exemplary diagram showing a structure of a radio interface protocol between a UE and a gNB.

FIGS. 6A and 6B are a signal flowchart illustrating an exemplary registration procedure.

FIGS. 7A and 7B are a signal flowchart illustrating an exemplary PDU session establishment procedure.

FIG. 8 shows an architecture for an Edge Application Server (EAS).

FIG. 9 shows an architecture in which an Intermediate SMF (I-SMF) is introduced.

FIG. 10 is a block diagram of a UE according to an embodiment.

FIG. 11 is a block diagram showing the configuration of a UE shown in FIG. 10 in more detail.

FIG. 12 shows a detailed block diagram of a processor shown in FIG. 10 or 11.

FIG. 13 is an exemplary diagram illustrating a signal flow according to one disclosure of the present specification.

FIG. 14 is an exemplary diagram illustrating a signal flow according to one disclosure of the present specification.

FIG. 15 is an exemplary diagram illustrating in detail a process of updating the UP path after step 7 shown in FIG. 13 and step 6 shown in FIG. 14.

FIG. 16 is a flowchart illustrating a step in which the UE may display a UI/UX screen in a procedure shown in FIG. 15.

FIG. 17A shows an example of a screen on which information informing that a PDU session is scheduled to be created is displayed.

FIG. 17B shows an example of a screen on which information informing the existence of an established PDU session is displayed.

FIG. 17C shows an example of a screen on which information informing that the PDU session has been released is displayed.

FIG. 18 is an exemplary diagram illustrating an example in which a processor shown in FIG. 12 is configured to display UI/UX.

FIG. 19 illustrates a communication system 1 applied to the disclosure of the present specification.

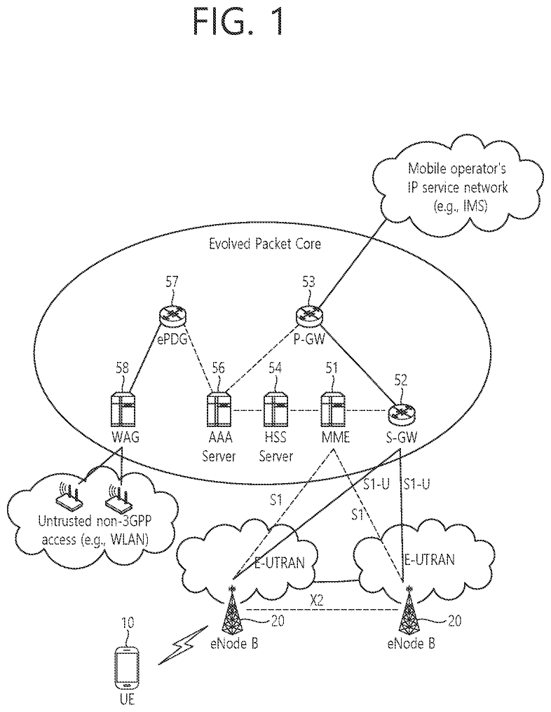

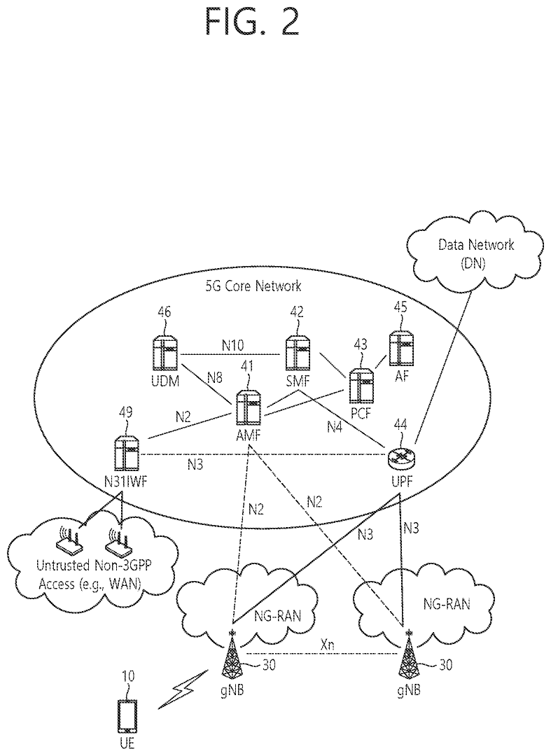

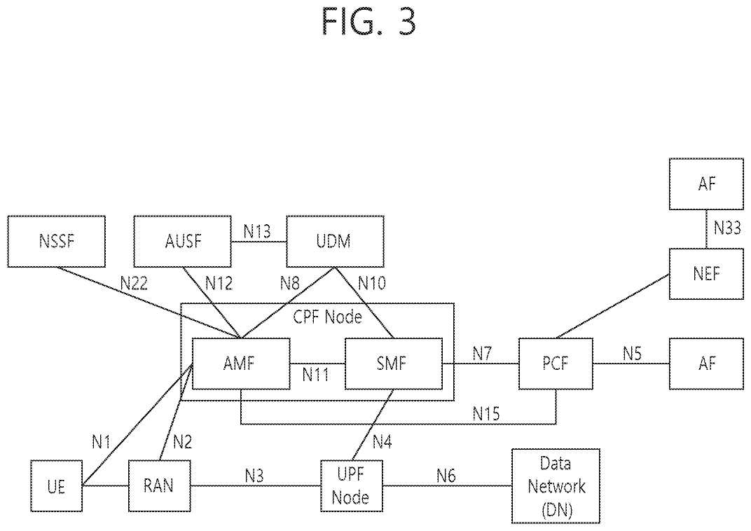

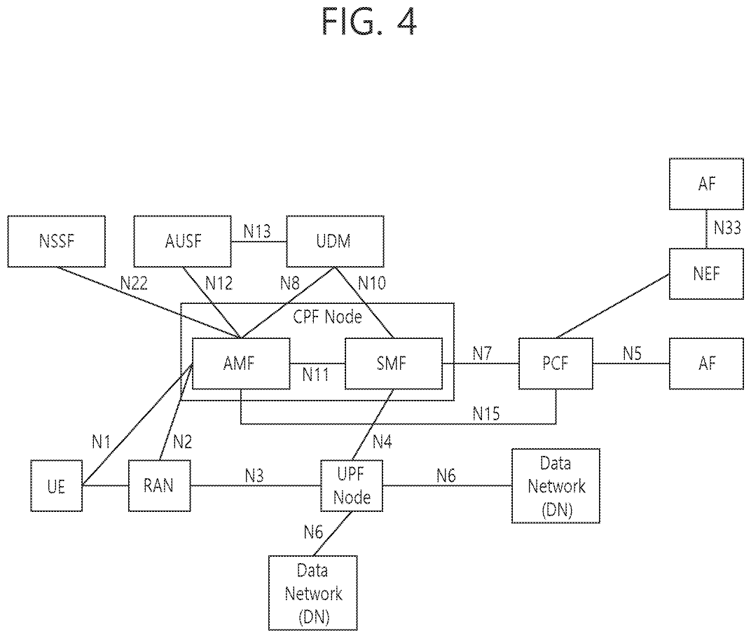

### DETAILED DESCRIPTION

The technical terms used herein are used to merely describe specific embodiments and should not be construed as limiting the present disclosure. Further, the technical terms used herein should be, unless defined otherwise, interpreted as having meanings generally understood by those skilled in the art but not too broadly or too narrowly. Further, the technical terms used herein, which are determined not to exactly represent the disclosure, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present disclosure includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present disclosure, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present disclosure.

It will be understood that when an element or layer is referred to as being “connected to” or “coupled to” another element or layer, it may be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present disclosure will be described in greater detail with reference to the accompanying drawings. In describing the present disclosure, for ease of understanding, the same reference numerals are used to denote the same components throughout the drawings, and repetitive description on the same components will be omitted. Detailed description on well-known arts which are determined to make the gist of the disclosure unclear will be omitted. The accompanying drawings are provided to merely make the disclosure readily understood, but not should be intended to be limiting of the disclosure. It should be understood that the disclosure may be expanded to its modifications, replacements or equivalents in addition to what is shown in the drawings.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

In the accompanying drawings, a User Equipment (UE) is illustrated by way of example, but the illustrated UE may also be referred to in terms of UE 100 (terminal), Mobile Equipment (ME), and the like. In addition, the UE may be a portable device such as a notebook computer, a mobile phone, a PDA, a smartphone, or a multimedia device or may be a non-portable device such as a PC or vehicle-mounted device.

<Registration Procedure>

In order to allow mobility tracking and data reception to be performed, and in order to receive a service, the UE needs to gain authorization. For this, the UE shall register to a network. The registration procedure is performed when the UE needs to perform initial registration to a 5G system. Additionally, the Registration Procedure is performed when the UE performs periodic registration update, when the UE relocates to a new Tracking Area (TA) in an Idle state, and when the UE needs to perform periodic registration renewal.

During the initial registration procedure, an ID of the UE may be obtained from the UE. The AMF may forward (or transfer) a PEI (IMEISV) to a UDM, SMF, and PCF.

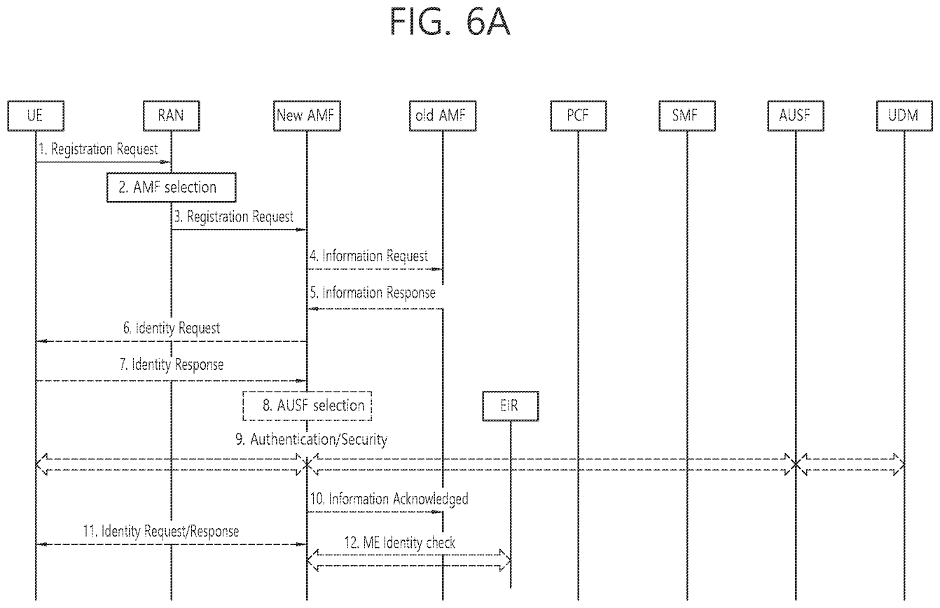

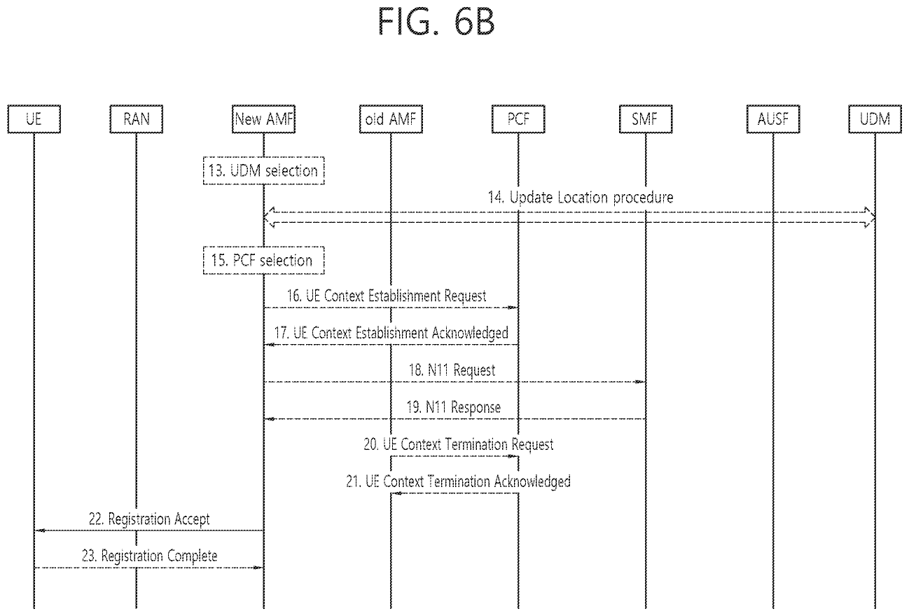

FIGS. 6A and 6B are a signal flowchart illustrating an exemplary registration procedure.

1) The UE may transmit an AN message to the RAN. The AN message may include an AN parameter and a registration request message. The registration request message may include information, such as a register type, a subscriber permanent ID or temporary user ID, a security parameter, Network Slice Selection Assistance Information (NSSAI), 5G capability of the UE, a Protocol Data Unit (PDU) session status, and so on.

In case of a 5G RAN, the AN parameter may include a Subscription Permanent Identifier (SUPI) or a temporary user ID, a selected network, and NSSAI.

The registration type may indicate whether the registration is an “initial registration” (i.e., the UE is in a non-registered state), “mobility registration update” (i.e., the UE is in a registered state, and the registration procedure is initiated by mobility), or “periodic registration update” (i.e., the UE is in a registered state, and the registration procedure is initiated due to the expiration of a periodic update timer). In case a temporary user ID is included, the temporary user ID indicates a last serving AMF. In case the UE has already been registered in a Public Land Mobile Network (PLMN) other than the PLMN of a 3GPP access through a non-3GPP access, the UE may not provide a UE temporary ID, which is allocated by the AMF during a registration procedure through the non-3GPP access.

The security parameter may be used for authentication and integrity protection.

The PDU session status indicates a PDU session that is available (and previously configured) in the UE.

2) In case the SUPI is included, or in case the temporary user ID does not indicate a valid AMF, the RAN may select an AMF based on a (R)AT and NSSAI.

In case the (R)AN cannot select an appropriate AMF, any AMF is selected according to a local policy, and the registration request is forwarded (or transferred) by using the selected AMF. If the selected AMF cannot provide service to the UE, the selected AMF may select another AMF that is more appropriate for the UE.

3) The RAN transmits an N2 message to a new AMF. The N2 message includes an N2 parameter and a registration request. The registration request may include a registration type, a subscriber permanent identifier or temporary user ID, a security parameter, NSSAI, MICO mode default settings (or configuration), and so on.

When a 5G-RAN is used, the N2 parameter includes location information related to a cell in which the UE is camping, a cell identifier, and a RAT type.

If the registration type indicated by the UE is a periodic registration update, Process 4 to Process 17, which will be described in detail later on, may not be performed.

4) The newly selected AMF may transmit an information request message to the previous AMF.

In case the temporary user ID of the UE is included in a registration request message, and in case the serving AMF is changed after the last registration, a new AMF may include an information request message, which includes complete registration request information for requesting SUPI and MM context of the UE, to the previous (or old) AMF.

5) The previous (or old) AMF transmits an information response message to the newly selected AMF. The information response message may include SUPI, MM context, and SMF information.

More specifically, the previous (or old) AMF transmits an information response message including SUPI and MM context of the UE.
In case information on an active PDU session is included in the previous (or old) AMF, SMF information including SMF ID and PDU session ID may be included in the information response message of the previous (or old) AMF.

6) In case the SUPI is not provided by the UE, or in case the SUPI is not searched from the previous (or old) AMF, the new AMF transmits an Identity Request message to the UE.

7) The UE transmits an Identity Response message including the SUPI to the new AMF.

8) The AMF may determine to perform triggering of an AUSF. In this case, the AMF may select an AUSF based on the SUPI.

9) The AUSF may initiate authentication of the UE and the NAS security function.

10) The new AMF may transmit an information response message to the previous (or old) AMF.

If the AMF is changed the new AMF may transmit the information response message in order to verify the forwarding of UE MM context.
If the authentication/security procedure is failed, the registration is rejected, and the new AMF may transmit a rejection message to the previous (or old) AMF.

11) The new AMF may transmit an Identity Request message to the UE.

In case a PEI is not provided by the UE, or in case a PEI is not searched from the previous (or old) AMF, an Identity Request message may be transmitted in order to allow the AMF to search the PEI.

12) The new AMF checks an ME identifier.

13) If Process 14, which will be described later on, is performed, the new AMF selects a UDM based on the SUPI.

14) If the AMF is modified after the final registration, if valid subscription context of the UE does not exist in the AMF, or if the UE provides a SUPI, wherein the AMF does not refer to a valid context, the new AMF initiates an Update Location procedure. Alternatively, even in a case where a UDM initiates Cancel Location for the previous AMF, the Update Location procedure may be initiated. The previous (or old) AMF discards the MM context and notifies all possible SMF(s), and, after obtaining AMF-related subscription data from the UDM, the new AMF generates MM context of the UE.

In case network slicing is used, the AMF obtains allowed NSSAI based on the requested NSSAI and UE subscription and local policy. In case the AMF is not appropriate for supporting the allowed NSSAI, the registration request is re-routed.

15) The new AMF may select a PCF based on the SUPI.

16) The new AMF transmits a UE Context Establishment Request message to the PCF. The AMF may request an operator policy for the UE to the PCF.

17) The PCF transmits a UE Context Establishment Acknowledged message to the new AMF.

18) The new AMF transmits an N11 request message to the SMF.

More specifically, when the AMF is changed, the new AMF notifies the new AMF that provides services to the UE to each SMF. The AMF authenticates the PDU session status from the UE by using available SMF information. In case the AMF is changed, the available SMF information may be received from the previous (or old) AMF. The new AMF may send a request to the SMF to release (or cancel) network resources related to a PDU session that is not activated in the UE.

19) The new AMF transmits an N11 response message to the SMF.

20) The previous (or old) AMF transmits a UE Context Termination Request message to the PCF.

In case the previous (or old) AMF has previously requested UE context to be configured in the PCF, the previous (or old) AMF may delete the UE context from the PCF.

21) The PCF may transmit a UE Context Termination Request message to the previous (or old) AMF.

22) The new AMF transmits a Registration Accept message to the UE. The Registration Accept message may include a temporary user ID, registration area, mobility restriction, PDU session status, NSSAI, periodic registration update timer, and allowed MICO mode.

The registration accept message may include information on the allowed NSSAI and the mapped NSSAI. The information on the allowed NSSAI information for the UE's access type may be contained within N2 messages containing the registration accept message. The information on the mapped NSSAI is information for mapping each S-NSSAI of the allowed NSSAI to the S-NASSI of the NSSAI set up for HPLMN.

In case the AMF allocated a new temporary user ID, the temporary user ID may be further included in the Registration Accept message. In case the mobility restriction is applied to the UE, information indicating the mobility restriction may be additionally included in the Registration Accept message. The AMF may include information indicating the PDU session status for the UE in the Registration Accept message. The UE may remove any internal resource being related to a PDU session that is not marked as being active from the received PDU session status. If the PDU session status information is included in the Registration Request, the AMF may include the information indicating the PDU session status to the UE in the Registration Accept message.

23) The UE transmits a Registration Complete message to the new AMF.

<PDU Session Establishment Procedure>

For the PDU Session Establishment procedure, two different types of PDU Session Establishment procedures may exist as described below.
A PDU Session Establishment procedure initiated by the UE.
A PDU Session Establishment procedure initiated by the network. For this, the network may transmit a Device Trigger message to an application (or applications) of the UE.

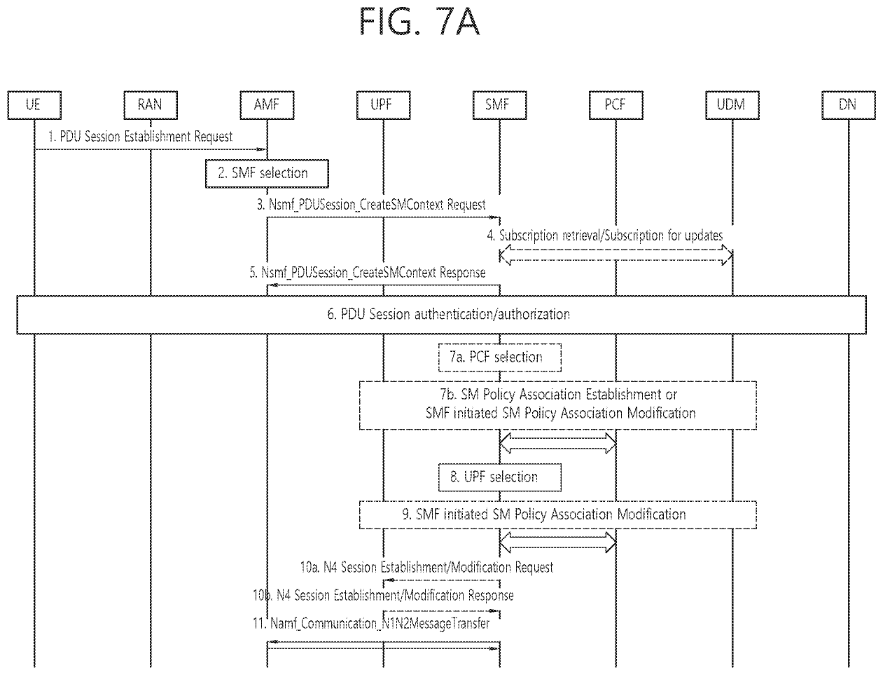

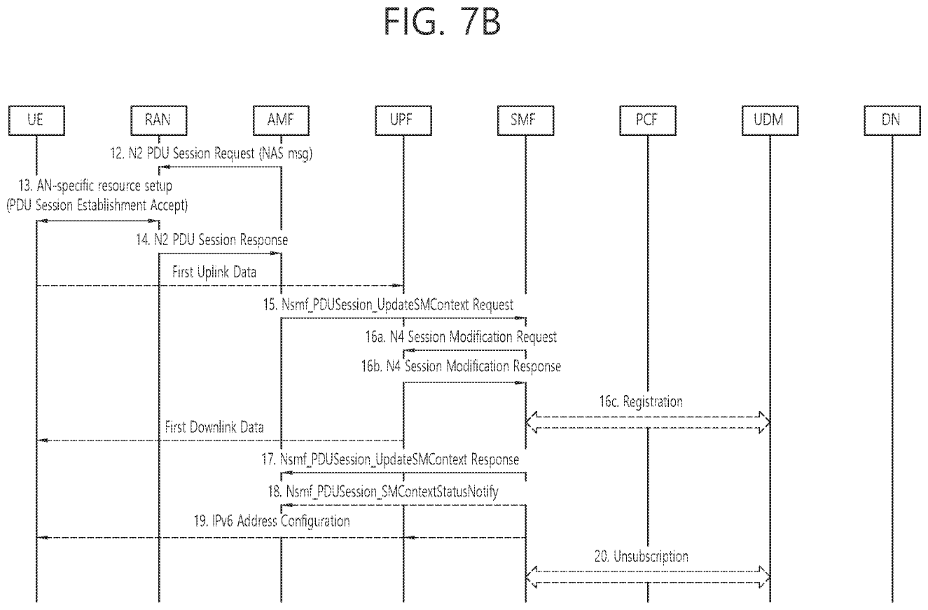

FIGS. 7A and 7B are a signal flowchart illustrating an exemplary PDU session establishment procedure.

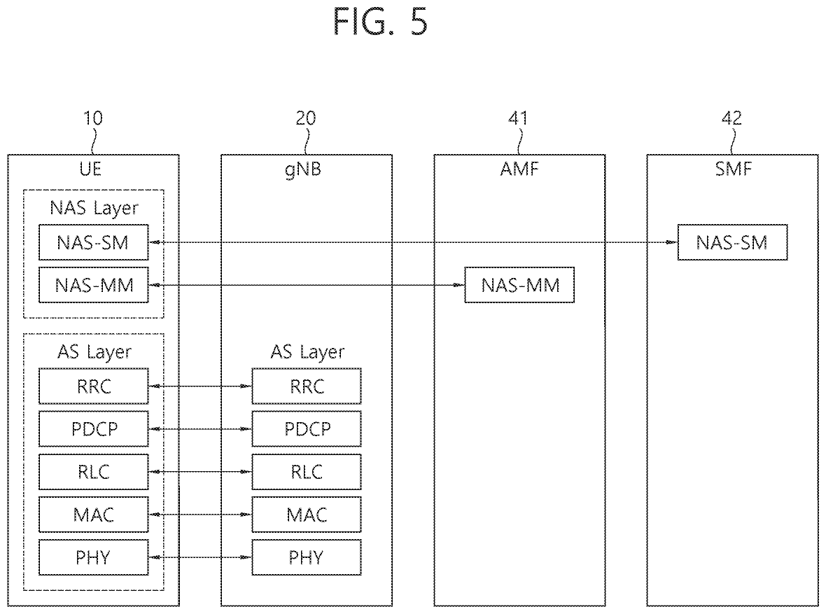

The procedure shown in FIGS. 6A and 6B assumes that the UE has already registered on the AMF according to the registration procedure shown in FIGS. 5a and 5b. Therefore, it is assumed that the AMF has already acquired user subscription data from UDM.

1) The UE transmits a NAS message to the AMF. The message may include Single-Network Slice Selection Assistance Information (S-NSSAI), DNN, PDU session ID, a Request type, N1 SM information, and so on.

Specifically, the UE includes S-NSSAI from allowed NSSAI for the current access type. If information on the mapped NSSAI has been provided to the UE, the UE may provide both S-NSSAI based on the allowed NSSAI and the corresponding S-NSSAI based on the information on the mapped NSSAI. Here, the information on the mapped NSSAI is information on mapping of each S-NSSAI in the allowed NSSAI to the S-NASSI in the NSSAI set up for HPLMN.

More specifically, the UE may extract and store the allowed NSSAI and the information on the mapped NSSAI, included in the registration accept message received from the network (i.e., AMF) in the registration procedure shown in FIG. 5. Therefore, the UE may transmit by including both S-NSSAI based on the allowed NSSAI and the corresponding S-NSSAI based on the information on the mapped NSSAI in the PDU session establishment request message.

In order to establish a new PDU session, the UE may generate a new PDU session ID.

By transmitting a NAS message having a PDU Session Establishment Request message included in N1 SM information, the PDU Session Establishment procedure that is initiated by the UE may be started. The PDU Session Establishment Request message may include a Request type, an SSC mode, and a protocol configuration option.

In case the PDU Session Establishment is for configuring a new PDU session, the Request type indicates “initial access”. However, in case an existing PDU session exists between the 3GPP access and the non-3GPP access, the Request type may indicate an “existing PDU session”.

The NAS message being transmitted by the UE is encapsulated within an N2 message by the AN. The N2 message is transmitted to the AMF and may include user location information and access technique type information.
The N1 SM information may include an SM PDU DN request container including information on a PDU session authentication performed by an external DN.

2) In case the request type indicates an “initial request”, and in case the PDU session ID has not been used for the existing PDU session of the UE, the AMF may determine that the message corresponds to a request for a new PDU session.

If the NAS message does not include the S-NSSAI, the AMF may determine default S-NSSAI for the requested PDU session according to the UE subscription. The AMF may relate a PDU session ID with an ID of the SMF and may store the PDU session ID.

The AMF may select SMF.

3) The AMF may transmit Nsmf_PDUSession_CreateSMContext Request message or Nsmf_PDUSession_UpdateSMContext Request message to the selected SMF.

The Nsmf_PDUSession_CreateSMContext Request message may include SUPI, DNN, S-NSSAI(s), PDU Session ID, AMF ID, Request Type, PCF ID, Priority Access, N1 SM container, User location information, Access Type, PEI, GPSI, UE presence in LADN service area, Subscription For PDU Session Status Notification, DNN Selection Mode, and Trace Requirements. The SM container may include a PDU Session Establishment Request message.

The Nsmf_PDUSession_UpdateSMContext Request message may include SUPI, DNN, S-NSSAI(s), SM Context ID, AMF ID, Request Type, N1 SM container, User location information, Access Type, RAT type, and PEI. The N1 SM container may include a PDU Session Establishment Request message.

The AMF ID is used to identify the AMF serving the UE. The N1 SM information may include a PDU session establishment request message received from the UE.

4) The SMF transmits a Subscriber Data Request message to the UDM. The Subscriber Data Request message may include a subscriber permanent ID and DNN. The UDM may transmit a Subscription Data Response message to the SMF.

In the above-described step 3, in case the Request type indicates an “existing PDU session”, the SMF determines that the corresponding request is caused by a handover between the 3GPP access and the non-3GPP access. The SMF may identify the existing PDU session based on the PDU session ID.

In case the SMF has not yet searched the SN-related subscription data for the UE that is related to the DNN, the SMF may request the subscription data.

The subscription data may include an authenticated Request type, an authenticated SSC mode, and information on a default QoS profile.

The SMF may verify whether or not the UE request follows the user subscription and local policy. Alternatively, the SMF may reject the UE request via NAS SM signaling (including the related SM rejection cause), which is forwarded (or transferred) by the AMF, and then the SMF may notify to the AMF that this shall be considered as a release of the PDU session ID.

5) The SMF transmits Nsmf_PDUSession_CreateSMContext Response message or Nsmf_PDUSession_UpdateSMContext Response message to the AMF.

The Nsmf_PDUSession_CreateSMContext Response message may include Cause, SM Context ID, or N1 SM container. The N1 SM container may include a PDU Session Reject.

In step 3 above, when the SMF has received the Nsmf_PDUSession_CreateSMContext Request message and the SMF can process the PDU Session establishment request message, the SMF creates SM context and the SM context ID is delivered to the AMF.

6) Secondary authentication/authorization is optionally performed.

7a) If the dynamic PCC is used for the PDU session, the SMF selects the PCF.

7b) The SMF performs an SM policy association establishment procedure in order to establish an SM policy association with the PCF.

8) If the request type in step 3 indicates “initial request”, the SMF selects the SSC mode for the PDU session. If step 5 is not performed, SMF may also select UPF. In case of the request type IPv4 or IPv6, the SMF may allocate an IP address/prefix for the PDU session.

9) The SMF provides information on the policy control request trigger condition by performing the SM policy association modification procedure.

10) If the request type indicates “initial request”, the SMF may start the N4 session establishment procedure using the selected UPF, otherwise may start the N4 session modification procedure using the selected UPF.

10a) The SMF transmits an N4 Session Establishment/Modification request message to the UPF. And, the SMF may provide packet discovery, execution, and reporting rules of packets that are to be installed in the UPF for the PDU session. In case the SMF allocates CN tunnel information, the CN tunnel information may be provided to the UPF.

10b) By transmitting an N4 Session Establishment/Modification response message, the UPF may respond. In case the CN tunnel information is allocated by the UPF, the CN tunnel information may be provided to the SMF.

11) The SMF transmits Namf_Communication_N1N2MessageTransfer message to the AMF. The Namf_Communication_N1N2MessageTransfer message may include PDU Session ID, N2 SM information, and N1 SM container.

The N2 SM information may include PDU Session ID, QoS Flow ID (QFI), QoS Profile(s), CN Tunnel Info, S-NSSAI from the Allowed NSSAI, Session-AMBR, PDU Session Type, User Plane Security Enforcement information, UE Integrity Protection Maximum Data Rate.

The N1 SM container may include a PDU session establishment accept message.

The PDU session establishment accept message may include an allowed QoS rule, SSC mode, S-NSSAI, and an assigned IPv4 address.

12) The AMF transmits an N2 PDU Session Request message to the RAN. The message may include N2 SM information and an NAS message. The NAS message may include a PDU session ID and a PDU Session Establishment Accept message.

The AMF may transmit an NAS message including a PDU session ID and a PDU Session Establishment Accept message. Additionally, the AMF may include the N2 SM information received from the SMF in the N2 PDU Session Request message and may then transmit the message including the N2 SM information to the RAN.

13) The RAN may perform a specific signaling exchange with a UE being related to the information received from the SMF.

The RAN also allocates RAN N3 tunnel information for the PDU session.

The RAN forwards the NAS message, which is provided in the step 10. The NAS message may include a PDU session ID and N1 SM information. The N1 SM information may include a PDU Session Establishment Accept message.

The RAN transmits the NAS message to the UE only in a case where a needed RAN resource is configured and allocation of RAN tunnel information is successful.

14) The RAN transmits an N2 PDU Session Response message to the AMF. The message may include a PDU session ID, a cause, and N2 SM information. The N2 SM information may include a PDU session ID, (AN) tunnel information, and a list of allowed/rejected QoS profiles.
The RAN tunnel information may correspond to an access network address of an N3 tunnel corresponding to the PDU session.

15) The AMF may transmit Nsmf_PDUSession_UpdateSMContext Request message to the SMF. The Nsmf_PDUSession_UpdateSMContext Request message may include N2 SM information. Herein, the AMF may forward the N2 SM information received from the RAN to the SMF.

16a) If an N4 session for the PDU session has not already been configured, the SMF may start an N4 Session Establishment procedure along with the UPF. Otherwise, the SMF may use the UPF to start an N4 Session Modification procedure. The SMF may provide AN tunnel information and CN tunnel information. The CN tunnel information shall be provided only in a case where the SMF selects the CN tunnel information in the step 8.

16b) The UPF may transmit an N4 Session Modification Response message to the SMF.

17) The SMF transmits Nsmf_PDUSession_UpdateSMContext Response message to the AMF.

After this step, the AMF can deliver the related event to the SMF.

18) The SMF transmits Nsmf_PDUSession_SMContextStatusNotify message.

19) The SMF transmits information to the UE through the UPF. More specifically, in case of PDU Type IPv6, the SMF may generate an IPv6 Router Advertisement and may transmit the generated advertisement to the UE through the N4 and UPF.

During the procedure, if the PDU Session Establishment is not successful, the SMF notifies this to the AMF.

<Edge Computing>

In 5G, edge computing is being discussed. Several architectures can be considered for edge computing.

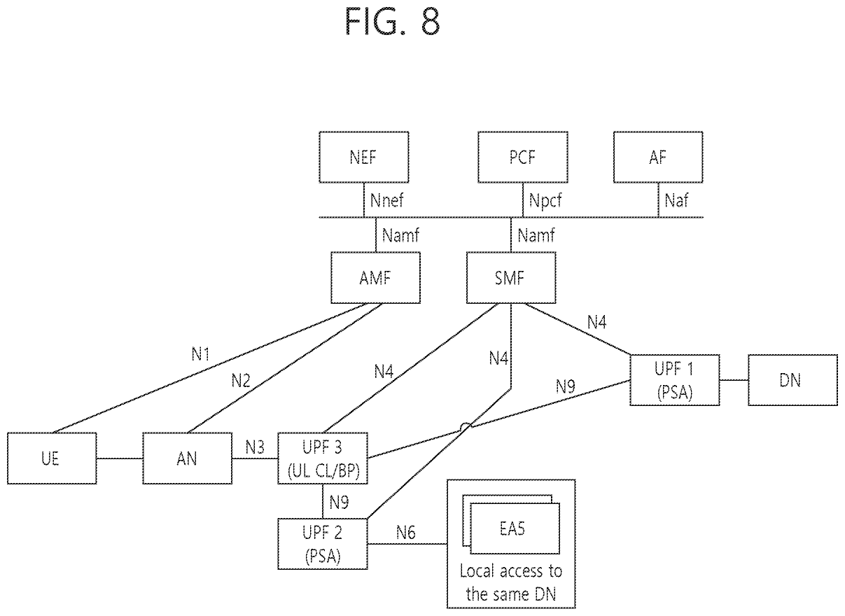

FIG. 8 shows an architecture for an Edge Application Server (EAS).

Referring to FIG. 8, a Data Network (DN) is connected to UPF 1 operating as a PDU Session Anchor (PSA). And the EAS is connected to UPF 2 operating as a PSA. The UPF 1 and UPF 2 are connected to UPF 3 operating as an Uplink Classifier (UL-CL)/Branching Point (BP).

All UPFs are connected to one SMF.

The illustrated architectures should be able to support a scenario where UEs are not aware of edge computing. In addition, the illustrated architectures should be able to support a scenario where UEs are edge computing aware. The illustrated architectures should be able to support a scenario where applications are not aware of edge computing.

Application clients within the UE can use edge computing without any special logic.

<Introduction of I-SMF>

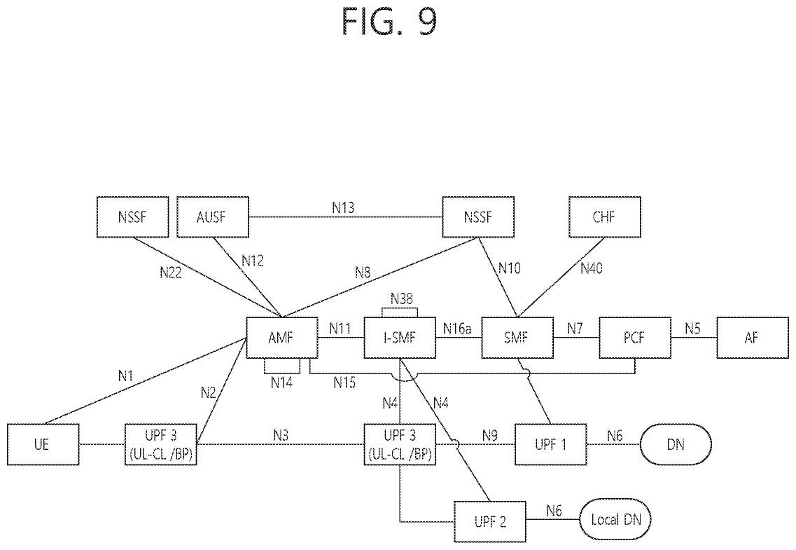

FIG. 9 shows an architecture in which an Intermediate SMF (I-SMF) is introduced.

As can be seen with reference to FIG. 9, UPF 1 is connected to a DN, and UPF 2 is connected to a local DN. The UPF 1 may be connected to the SMF, and the UPF 2 may be connected to the I-SMF.

<Traffic Routing>

On the other hand, the activation of traffic routing to the local DN for each Application Function (AF) request will be described.

In order to enable traffic routing to the local DN, a Data Network Access Identifier (DNAI) may be configured in the SMF.

The AF may send requests that affect SMF routing decisions for PDU session traffic. The AF's request affects the selection or reselection of the UPF, and the routing of user traffic to local access to the DN by DNAI.

The AF may send the request on behalf of an application not provided by the PLMN serving the UE.

If the operator does not allow the AF to access the network directly, the AF can use the NEF to interact with the 5GC.

The AF may be responsible for reselection or reallocation of applications within the local DN.

The AF may request notification of events related to PDU sessions.

The AF request may be forwarded to the PCF through the N5 interface or through the NEF.

The PCF may convert the AF request into a policy applied to the PDU session.

When the SMF receives a PCC rule to enable traffic routing to the local DN, the SMF may check whether the requested DNAI is supported by the SMF or the I-SMF. If neither SMF nor I-SMF support the requested DNAI, the SMF may not be able to enable the traffic routing setup to the local DN.

The AF request information may be stored in the UDR by the NEF.

<Problems to be Solved by the Disclosure of the Present Specification>

As described above, the AF request may affect the selection or reselection of the UPF, but not the SMF selection.

On the other hand, in order to route traffic to the local DN by selecting the I-SMF, an interface may exist between the I-SMF and the SMF as shown in FIG. 9.

However, in an edge computing environment for providing various services using 5G, it is necessary to consider a unique situation. For example, there may be a situation in which a third party service provider wants to use a dedicated SMF or UPF for reasons of security or its own policy. Therefore, there is a need for a control method capable of routing traffic to a local DN without using an interface between I-SMF and SMF.

<Device to which the Disclosure of the Present Specification can be Applied>

Hereinafter, a device to which the disclosure of the present specification can be applied will be described.

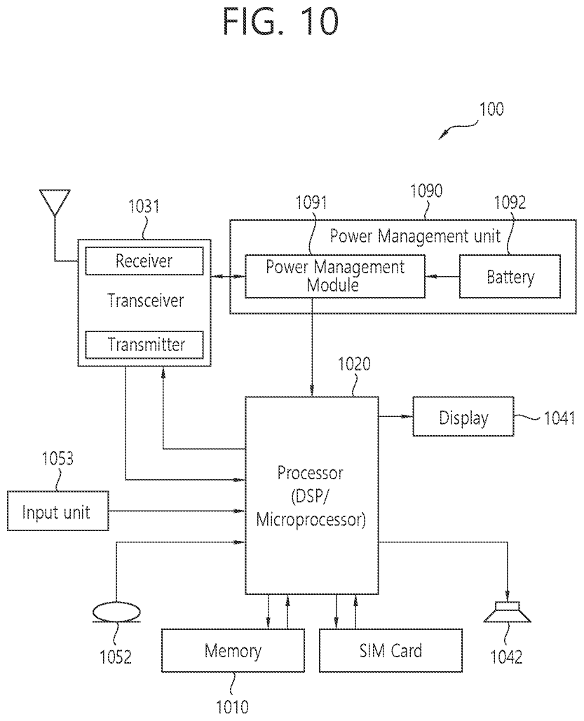

FIG. 10 is a block diagram of a UE according to an embodiment.

As can be seen with reference to FIG. 10, a UE 100 includes a memory 1010, a processor 1020, a transceiver 1031, a power management module 1091, a battery 1092, a display 1041, an input unit 1053, a speaker 1042, a microphone 1052, a Subscriber Identification Module (SIM) card, and one or more antennas.

The processor 1020 may be configured to implement the proposed function, process and/or method described in the present specification. Layers of a wireless interface protocol may be implemented in the processor 1020. The processor 1020 may include Application-Specific Integrated Circuit (ASIC), other chipset, logical circuit and/or data processing apparatus. The processor 1020 may be an Application Processor (AP). The processor 1020 may include at least one of a Digital Signal Processor (DSP), a Central Processing Unit (CPU), a Graphics Processing Unit (GPU) and a modulator and demodulator (Modem). An example of the processor 1020 may be SNAPDRAGON™ series processor manufactured by Qualcomm®, EXYNOS™ series processor manufactured by Samsung®, A series processor manufactured by Apple®, HELIO™ series processor manufactured by MediaTek®, ATOM™ series processor manufactured by INTEL®, or the corresponding next generation processor.

The power management module 1091 manages a power for the processor 1020 and/or the transceiver 1031. The battery 1092 supplies power to the power management module 1091. The display 1041 outputs the result processed by the processor 1020. The input unit 1053 receives an input to be used by the processor 1020. The input unit 1053 may be displayed on the display 1041. The SIM card is an integrated circuit used to safely store International Mobile Subscriber Identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include Read-Only Memory (ROM), Random Access Memory (RAM), flash memory, a memory card, a storage medium, and/or other storage device. When the embodiment is implemented in software, the techniques described in the present specification may be implemented in a module (e.g., process, function, etc.) for performing the function described in the specification. A module may be stored in the memory 1010 and executed by the processor 1020. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020 in a way to operate and transmits and/or receives a radio signal. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives a sound related input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 such that a user identifies it or for convenience.

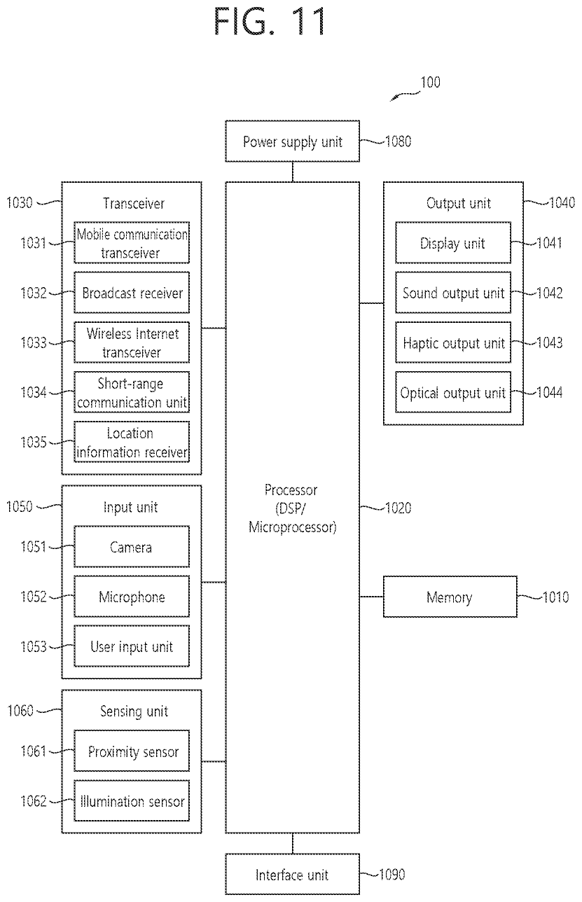

FIG. 11 is a block diagram showing the configuration of a UE shown in FIG. 10 in more detail.

The terminal 100 may include a transceiver unit 1030, a processor 1020, a memory 1030, a sensing unit 1060, an output unit 1040, an interface unit 1090, an input unit 1050, and a power supply unit 1080, etc. Since the components shown in FIG. 11 are not essential for implementing the terminal, the terminal described in this specification may have more or fewer components than those listed above.

More specifically, among the components, the transceiver 1030 include one or more modules that enable wireless communication between the terminal 100 and the wireless communication system, between the terminal 100 and another terminal 100, or between the terminal 100 and an external server. In addition, the transceiver 1030 may include one or more modules for connecting the terminal 100 to one or more networks.

The transceiver 1030 may include at least one of a broadcast receiver 1032, a mobile communication transceiver 1031, a wireless Internet transceiver 1033, a short-range communication unit 1034, and a location information receiver 1035.

The input unit 1050 includes a camera 1051 or an image input unit for inputting an image signal, a microphone 1052 or an audio input unit for inputting an audio signal, and a user input unit 1053 for receiving information from a user, for example, a touch key, a push key (mechanical key), etc. The voice data or image data collected by the input unit 1050 may be analyzed and processed as a user's control command.

The sensing unit 1060 may include one or more sensors for sensing at least one of information in the mobile terminal, surrounding environment information surrounding the mobile terminal, and user information. For example, the sensing unit 1060 may include a proximity sensor 1061, an illumination sensor 1062, an illumination sensor, a touch sensor, an acceleration sensor, a magnetic sensor, gravity Sensor (G-sensor), gyroscope sensor, motion sensor, RGB sensor, infrared sensor (IR sensor: infrared sensor), fingerprint sensor (finger scan sensor), ultrasonic sensor, optical sensors (e.g., cameras 1051), microphones 1052, battery gauges, environmental sensors (e.g., barometers, hygrometers, thermometers, radiation sensors, It may include at least one of a thermal sensor, a gas sensor, etc.) and a chemical sensor (e.g., an electronic nose, a healthcare sensor, a biometric sensor, etc.). Meanwhile, the mobile terminal disclosed in the present specification may combine and utilize information sensed by at least two or more of these sensors.

The output unit 1040 is for generating an output related to visual, auditory or tactile sense, the output unit 1040 may include at least one of a display unit 1041, a sound output unit 1042, a haptic output unit 1043, and an optical output unit 1044. The display unit 1041 may implement a touch screen by forming a layer structure with the touch sensor each other or integrally formed with the touch sensor. Such a touch screen may function as a user input unit 1053 that provides an input interface between the terminal 100 and a user, and may provide an output interface between the terminal 100 and a user.

The interface unit 1090 serves as a passage with various types of external devices connected to the terminal 100. This interface unit 1090 may include at least one of a wired/wireless headset port (port), an external charger port (port), a wired/wireless data port (port), a memory card (memory card) port, a port connecting a device equipped with an identification module, an audio input/output (I/O) port, a video input/output (I/O) port, and an earphone port. Corresponding to the connection of the external device to the interface unit 1090, the terminal 100 may perform appropriate control related to the connected external device.

In addition, the memory 1030 stores data supporting various functions of the terminal 100. The memory 1030 may store a plurality of application programs (or applications) driven in the terminal 100, data for operation of the terminal 100, and commands. At least some of these application programs may be downloaded from an external server through wireless communication. Also, at least some of these application programs may exist on the terminal 100 from the time of shipment for basic functions (e.g., functions for incoming calls, outgoing functions, message reception, and message outgoing functions) of the terminal 100. Meanwhile, the application program may be stored in the memory 1030, installed on the terminal 100, and driven by the processor 1020 to perform an operation (or function) of the mobile terminal.

The processor 1020 generally controls the overall operation of the terminal 100 in addition to the operation related to the application program. The processor 1020 may provide or process appropriate information or functions to a user by processing signals, data, information, etc. input or output through the above-described components or by driving an application program stored in the memory 1030.

In addition, the processor 1020 may control at least some of the aforementioned components in order to drive an application program stored in the memory 1030. Furthermore, the processor 1020 may operate by combining at least two or more of the components included in the terminal 100 to drive the application program.

The power supply unit 1080 receives external power and internal power under the control of the processor 1020 to supply power to each component included in the terminal 100. The power supply unit 1080 includes a battery, and the battery may be a built-in battery or a replaceable battery.

At least some of the respective components may operate in cooperation with each other to implement an operation, control, or control method of a mobile terminal according to various embodiments to be described below. In addition, the operation, control, or control method of the mobile terminal may be implemented on the mobile terminal by driving at least one application program stored in the memory 1030.

Hereinafter, before looking at various embodiments implemented through the terminal 100 as described above, the above-listed components will be described in more detail with reference to the drawings.

First, referring to the transceiver 1030, the broadcast receiver 1032 of the transceiver 1030 receives a broadcast signal and/or broadcast related information from an external broadcast management server through a broadcast channel. The broadcast channel may include a satellite channel and a terrestrial channel. Two or more of the broadcast reception modules may be provided to the mobile terminal 100 for simultaneous broadcast reception or broadcast channel switching for at least two broadcast channels.

The mobile communication transceiver 1031 transmit and receive wireless signal with at least one of a base station, an external terminal, and a server on a mobile communication network constructed according to the technical standards or communication methods for mobile communication (e.g., Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), LTE Advanced (LTE-A), 3GPP New Radio access technology (NR), etc.).

The wireless signal may include various types of data according to transmission and reception of a voice call signal, a video call signal, or a text/multimedia message.

The wireless Internet transceiver 1033 refers to a module for wireless Internet access, and may be built-in or external to the terminal 100. The wireless Internet transceiver 1033 is configured to transmit and receive wireless signals in a communication network according to wireless Internet technologies.

As wireless Internet technologies, for example, Wireless LAN (WLAN), Wi-Fi, Wi-Fi Direct, Digital Living Network Alliance (DLNA), WiBro, WiMAX, HSDPA, HSUPA, LTE, LTE-A, 3GPP NR, and the like. The Internet transceiver 1033 transmits and receives data according to at least one wireless Internet technology within a range including Internet technologies not listed above.

From the point of view that wireless Internet access by WiBro, HSDPA, HSUPA, GSM, CDMA, WCDMA, LTE, LTE-A, 3GPP NR, etc., is made through a mobile communication network, the wireless Internet transceiver 1033 performing wireless Internet access through the mobile communication network may be understood as a type of the mobile communication transceiver 1031.

The short-range communication unit 1034 is for short-range communication, and may support short-distance communication by using at least one of Bluetooth™, Radio Frequency Identification (RFID), Infrared Data Association (IrDA), Ultra Wideband (UWB), ZigBee, Near Field Communication (NFC), Wi-Fi, Wi-Fi Direct, and Wireless Universal Serial Bus (USB) technologies. The short-distance communication unit 1034 may support wireless communication between the terminal 100 and the wireless communication system, between the terminal 100 and the other terminal 100, or between the terminal 100 and another network in which the other terminal (100, or external server) is located. The local area network may be wireless personal area networks.

Here, the other terminal 100 may be a wearable device capable of exchanging (or interworking) data with the terminal 100, e.g., a smart watch, a smart glass, neckband, Head Mounted Display (HMD). The short-range communication unit 1034 may detect (or recognize) a wearable device capable of communicating with the terminal 100 in the vicinity of the terminal 100. Furthermore, when the detected wearable device is a device authenticated to communicate with the terminal 100, the processor 1020 may transmit at least a portion of data processed by the terminal 100 to a wearable device through the short-range communication unit 1034. Accordingly, the user of the wearable device may use data processed by the terminal 100 through the wearable device. For example, according to this, when a call is received in the terminal 100, it is possible for the user to perform a phone call through the wearable device. When a message is received in the terminal 100, it is possible for the user to check the received message through the wearable device.

Furthermore, screen mirroring with a TV located in the house or a display inside a car is performed through the short-distance communication unit 1034, and a corresponding function is performed based on, for example, the MirrorLink or Miracast standard. In addition, it is also possible to directly control a TV or a display inside a vehicle by using the terminal 100.

The location information module 1035 is a module for acquiring a location (or current location) of a mobile terminal, and a representative example thereof includes a Global Positioning System (GPS) module or a Wireless Fidelity module. For example, if the mobile terminal utilizes a GPS module, it can acquire the location of the mobile terminal by using a signal transmitted from a GPS satellite. As another example, if the mobile terminal utilizes the Wi-Fi module, the location of the mobile terminal may be obtained based on information of the Wi-Fi module and a wireless Access Point (AP) that transmits or receives a wireless signal. If necessary, the location information module 1035 may perform any function of the other modules of the transceiver 1030 to obtain data on the location of the mobile terminal as a substitute or additionally. The location information module 1035 is a module used to obtain the location (or current location) of the mobile terminal, and is not limited to a module that directly calculates or obtains the location of the mobile terminal.

Each of the broadcast receiver 1032, the mobile communication transceiver 1031, the short-range communication unit 1034, and the location information module 1035 may be implemented as a separate module performing a corresponding function, and functions corresponding to two or more of the transceiver 1031, the short-range communication unit 1034, and the location information module 1035 may be implemented by one module.

Next, the input unit 1050 is for inputting image information (or signal), audio information (or signal), data, or information input from a user, for input of image information, the terminal 100 may be provided with one or a plurality of cameras 1051. The camera 1051 processes an image frame such as a still image or a moving image obtained by an image sensor in a video call mode or a photographing mode. The processed image frame may be displayed on the display unit 1041 or stored in the memory 1030. On the other hand, the plurality of cameras 1051 provided in the terminal 100 may be arranged to form a matrix structure, and through the cameras 1051 forming the matrix structure as described above, image information may be input to the terminal 100 has a plurality of cameras having various angles or focal points. In addition, the plurality of cameras 1051 may be arranged in a stereo structure to acquire a left image and a right image for realizing a stereoscopic image.

The microphone 1052 processes an external sound signal as electrical voice data. The processed voice data may be utilized in various ways according to a function (or a running application program) being performed by the terminal 100. Meanwhile, various noise removal algorithms for removing noise generated in the process of receiving an external sound signal may be implemented in the microphone 1052.

The user input unit 1053 is for receiving information from a user, and when information is input through the user input unit 1053, the processor 1020 may control the operation of the terminal 100 to correspond to the input information. The user input unit 1053 is a mechanical input means (or a mechanical key, for example, a button located on the front, rear or side of the terminal 100, a dome switch, a jog wheel, a jog switch, etc.) and a touch input means. As an example, the touch input means consists of a virtual key, a soft key, or a visual key displayed on the touch screen through software processing, or consists of a touch key (touch key) disposed on a part other than the touch screen. On the other hand, the virtual key or the visual key, is possible to be displayed on the touch screen while having various forms, for example, graphic, text, icon, video or a combination of these forms.

Meanwhile, the sensing unit 1060 senses at least one of information in the mobile terminal, surrounding environment information surrounding the mobile terminal, and user information, and generates a sensing signal corresponding thereto. The processor 1020 may control the driving or operation of the terminal 100 or perform data processing, functions, or operations related to an application program installed in the terminal 100 based on the sensing signal. Representative sensors among various sensors that may be included in the sensing unit 1060 will be described in more detail.

First, the proximity sensor 1061 refers to a sensor that detects the presence or absence of an object approaching a predetermined detection surface or an object existing in the vicinity without mechanical contact using the force of an electromagnetic field or infrared rays. The proximity sensor 1061 may be disposed in an inner region of the mobile terminal covered by the touch screen described above or in the vicinity of the touch screen.

Examples of the proximity sensor 1061 include a transmission type photoelectric sensor, a direct reflection type photoelectric sensor, a mirror reflection type photoelectric sensor, a high frequency oscillation type proximity sensor, a capacitive type proximity sensor, a magnetic type proximity sensor, an infrared proximity sensor, and the like. In the case where the touch screen is capacitive, the proximity sensor 1061 may be configured to detect the proximity of an object having conductivity as a change in an electric field according to the proximity of the object. In this case, the touch screen (or touch sensor) itself may be classified as a proximity sensor.

On the other hand, for convenience of description, the act of approaching an object on the touch screen without being in contact so that the object is recognized that it is located on the touch screen is called “proximity touch”, and the act of actually touching an object on the screen is called “contact touch”. The position where the object is touched in proximity on the touch screen means a position where the object is perpendicular to the touch screen when the object is touched in proximity. The proximity sensor 1061 may detect a proximity touch and a proximity touch pattern (e.g., proximity touch distance, proximity touch direction, proximity touch speed, proximity touch time, proximity touch position, proximity touch movement state, etc.). On the other hand, the processor 1020 processes data (or information) corresponding to the proximity touch operation and the proximity touch pattern detected through the proximity sensor 1061 as above, and further, print visual information corresponding to the processed data on the touch screen. Furthermore, the processor 1020 may control the terminal 100 to process different operations or data (or information) according to whether a touch to the same point on the touch screen is a proximity touch or a contact touch.

The touch sensor detects a touch (or touch input) applied to the touch screen (or the display unit 1041) using at least one of various touch methods such as a resistive film method, a capacitive method, an infrared method, an ultrasonic method, and a magnetic field method, etc.

As an example, the touch sensor may be configured to convert a change in pressure applied to a specific part of the touch screen or a change in capacitance occurring in a specific part of the touch screen into an electrical input signal. The touch sensor may be configured to detect a position in which a touch object applying a touch on the touch screen, an area, a pressure at the time of touch, an electrostatic capacitance at the time of touch, etc. Here, the touch object is an object that applies a touch to the touch sensor, and may be, for example, a finger, a touch pen or a stylus pen, a pointer, or the like.

As such, when there is a touch input to the touch sensor, a signal(s) corresponding thereto is sent to the touch controller. The touch controller processes the signal(s) and then sends the corresponding data to the processor 1020. Accordingly, the processor 1020 may know which area of the display unit 1041 has been touched, and the like. Here, the touch controller may be a component separate from the processor 1020, or may be the processor 1020 itself.

Meanwhile, the processor 1020 may perform different controls or may perform the same control according to the type of the touch object that touches the touch screen (or a touch key provided other than the touch screen). Whether to perform different control or the same control according to the type of the touch object may be determined according to the current operating state of the terminal 100 or a running application program.

On the other hand, the touch sensor and the proximity sensor described above are independently or in combination, may sense various types of touch such as, a short (or tap) touch, a long touch, a multi touch, and a drag touch, flick touch, pinch-in touch, pinch-out touch, swipe touch, hovering touch, etc.

The ultrasonic sensor may recognize location information of a sensing target by using ultrasonic waves. Meanwhile, the processor 1020 may calculate the position of the wave source based on information sensed by the optical sensor and the plurality of ultrasonic sensors. The position of the wave source may be calculated using the property that light is much faster than ultrasonic waves, that is, the time at which light reaches the optical sensor is much faster than the time at which ultrasonic waves reach the ultrasonic sensor. More specifically, the position of the wave source may be calculated by using a time difference from the time that the ultrasonic wave arrives using light as a reference signal.

On the other hand, the camera 1051 as described in terms of the components of the input unit 1050 includes at least one of a camera sensor (e.g., CCD, CMOS, etc.), a photo sensor (or an image sensor), and a laser sensor.

The camera 1051 and the laser sensor may be combined with each other to detect a touch of a sensing target for a 3D stereoscopic image. The photo sensor may be stacked on the display device, and the photo sensor is configured to scan the motion of the sensing target close to the touch screen. More specifically, the photo sensor mounts photo diodes and transistors (TRs) in rows/columns and scans the contents placed on the photo sensors using electrical signals that change according to the amount of light applied to the photo diodes. That is, the photo sensor calculates the coordinates of the sensing target according to the amount of change in light, and through this, location information of the sensing target can be obtained.

The display unit 1041 displays (outputs) information processed by the terminal 100. For example, the display unit 1041 may display execution screen information of an application program driven in the terminal 100 or User Interface (UI) and Graphic User Interface (GUI) information according to the execution screen information.

Also, the display unit 1041 may be configured as a stereoscopic display unit for displaying a stereoscopic image.

A three-dimensional display method such as a stereoscopic method (glasses method), an auto stereoscopic method (glasses-free method), or a projection method (holographic method) may be applied to the stereoscopic display unit.

The sound output unit 1042 may output audio data received from the transceiver 1030 or stored in the memory 1030 in a call signal reception, a call mode or a recording mode, a voice recognition mode, a broadcast reception mode, and the like. The sound output unit 1042 also outputs a sound signal related to a function (e.g., a call signal reception sound, a message reception sound, etc.) performed in the terminal 100. The sound output unit 1042 may include a receiver, a speaker, a buzzer, and the like.

The haptic module 1530 generates various tactile effects that the user can feel. A representative example of the tactile effect generated by the haptic output unit 1043 may be vibration. The intensity and pattern of vibration generated by the haptic output unit 1043 may be controlled by a user's selection or setting of a processor. For example, the haptic output unit 1043 may synthesize and output different vibrations or output them sequentially.

In addition to vibration, the haptic output unit 1043 may generate various tactile effects such as a pin arrangement that moves vertically with respect to the contact skin surface, a jet or suction force of air through a nozzle or an inlet, a touch on the skin surface, contact of an electrode, an electrostatic force, effect caused by heat absorption and the effect of reproducing a feeling of coolness and warmth using an element capable of absorbing heat or generating heat, etc.

The haptic output unit 1043 may not only deliver a tactile effect through direct contact, but may also be implemented so that the user can feel the tactile effect through a muscle sensation such as a finger or arm. Two or more haptic output units 1043 may be provided according to the configuration of the terminal 100.

The light output unit 1044 outputs a signal for notifying the occurrence of an event by using the light of the light source of the terminal 100. Examples of the event generated in the terminal 100 may be message reception, call signal reception, missed call, alarm, schedule notification, email reception, information reception through an application, and the like.

The signal output from the optical output unit 1044 is implemented as the mobile terminal emits light of a single color or a plurality of colors toward the front or rear side. The signal output may be terminated when the mobile terminal detects the user's event confirmation.

The interface unit 1090 serves as a passage with all external devices connected to the terminal 100. The interface unit 1090 receives data from an external device, receives power and transmits it to each component inside the terminal 100, or allows data inside the terminal 100 to be transmitted to an external device. For example, a wired/wireless headset port, an external charger port, a wired/wireless data port, a memory card port, a port for connecting a device equipped with an identification module (port), an audio I/O port, a video I/O port, an earphone port, etc. may be included in the interface unit 1090.

On the other hand, the identification module is a chip storing various information for authenticating the use authority of the terminal 100, the identification module may include a User Identification Module (UIM), a Subscriber Identification Module (SIM), a Universal Subscriber Identification Module (USIM) and the like. A device equipped with an identification module (hereinafter, ‘identification device’) may be manufactured in the form of a smart card. Accordingly, the identification device may be connected to the terminal 100 through the interface unit 1090.

In addition, the interface unit 1090 may be a path through which power from the cradle is supplied to the terminal 100 when the terminal 100 is connected to an external cradle, or a path through which various commands signal input from the cradle by the user transmitted to the terminal 100. Various command signals or the power input from the cradle may be operated as signals for recognizing that the terminal 100 is correctly mounted on the cradle.

The memory 1030 may store a program for the operation of the processor 1020, and may temporarily store input/output data (e.g., a phone book, a message, a still image, a moving image, etc.). The memory 1030 may store data related to vibrations and sounds of various patterns output when a touch input is performed on the touch screen.

The memory 1030 may include at least one type of storage medium such as a flash memory type, a hard disk type, a Solid State Disk (SSD) type, a Silicon Disk Drive (SDD) type, and a multimedia card micro type, card-type memory (such as SD or XD memory), Random Access Memory (RAM), Static Random Access Memory (SRAM), Read-Only Memory (ROM), Electrically Erasable Programmable Read-Only Memory (EEPROM), a Programmable Read-Only Memory (PROM), a magnetic memory, a magnetic disk, and an optical disk. The terminal 100 may be operated in relation to a web storage that performs a storage function of the memory 1030 on the Internet.

Meanwhile, as described above, the processor 1020 controls the operation related to the application program and the general operation of the terminal 100 in general. For example, if the state of the mobile terminal satisfies a set condition, the processor 1020 may execute or release a lock state that restricts input of a user's control command to applications.

In addition, the processor 1020 may perform control and processing related to voice calls, data communication, video calls, etc., or perform pattern recognition processing capable of recognizing handwriting input or drawing input performed on the touch screen as text and images, respectively. Furthermore, the processor 1020 may control any one or a plurality of the components described above in combination to implement various embodiments described below on the terminal 100.

The power supply unit 1080 receives external power and internal power under the control of the processor 1020 to supply power necessary for operation of each component. The power supply unit 1080 includes a battery, and the battery may be a built-in battery configured to be rechargeable, and may be detachably coupled to the terminal body for charging or the like.

In addition, the power supply unit 1080 may include a connection port, and the connection port may be configured as an example of the interface 1090 to which an external charger that supplies power for charging the battery is electrically connected.

As another example, the power supply unit 1080 may be configured to charge the battery in a wireless manner without using the connection port. In this case, power can be transmitted to the power supply unit 1080 uses one or more of an inductive coupling method based on a magnetic induction phenomenon or a resonance coupling method based on an electromagnetic resonance phenomenon from an external wireless power transmitter.

Meanwhile, various embodiments below may be implemented in, for example, a computer-readable recording medium using software, hardware, or a combination thereof.

On the other hand, the mobile terminal can be extended to a wearable device that can be worn on the body beyond the dimension that the user mainly holds in the hand. Such wearable devices include a smart watch, smart glass, and Head Mounted Display (HMD) and the like. Hereinafter, examples of mobile terminals extended to wearable devices will be described.

The wearable device may be configured to be able to exchange (or interwork) data with another terminal 100. The short-range communication unit 1034 may detect (or recognize) a wearable device capable of communicating around the terminal 100. Furthermore, when the detected wearable device is a device authenticated to communicate with the terminal 100, the processor 1020 may transmit at least a portion of data processed in the terminal 100 to the wearable device through the short-range communication unit 1034. Accordingly, the user may use data processed by the terminal 100 through the wearable device. For example, it is possible to perform a phone call through the wearable device when a call is received in the terminal 100, or to check the received message through the wearable device when a message is received to the terminal 100.

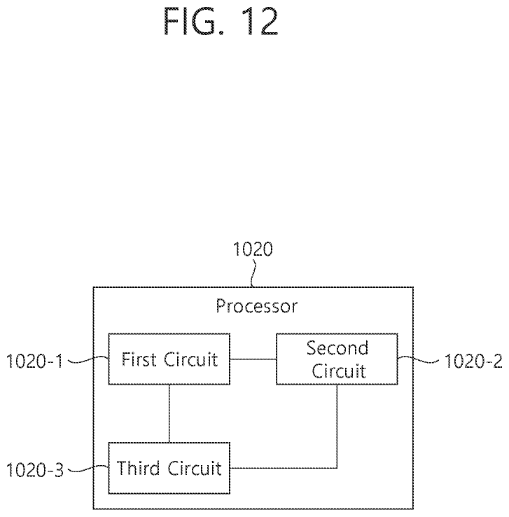

FIG. 12 shows a detailed block diagram of a processor shown in FIG. 10 or 11.

As can be seen with reference to FIG. 12, a processor 1020 in which the disclosure of the present specification is implemented may include a plurality of circuitries to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

<Disclosure of the Present Specification>

The disclosures of the present specification provide methods for solving the above-described problems.

The disclosures of the present specification consist of a combination of one or more operations/configurations/steps described below.

### I. Overview of the Disclosures of the Present Specification

I-1. Network Node Function

The AF of the third party or the AF of the mobile operator sends a request to the core network to use the UPF with the dedicated control node in a specific location and in a specific situation (time/place, etc.).

The request may include the DNAI and AF request level. The DNAI may be information necessary for SMF and UPF selection. The AF request level may be a simple indication divided into on/off and 0/1, but may have various levels according to the business agreement between the operator and the service provider, and the level is considered as one of the basic information for new SMF selection.

I-1-2. Network Control Node (e.g., AMF)

SMF selection is performed according to the information received from the AF (DNAI, AF request level, or a changed indication recognized by the core network).

The SMF selection result by the AF request is sent to the SMF, providing information that can trigger change of the UP path.

I-2. UE Function

The UE may perform procedures such as deactivation/release and re-activation/re-establishment of a PDU session based on information obtained directly or indirectly from the network.

### II. Implementation Example

Although each of the following drawings shows an embodiment of each disclosure, the embodiments of the drawings may be implemented in combination with each other.

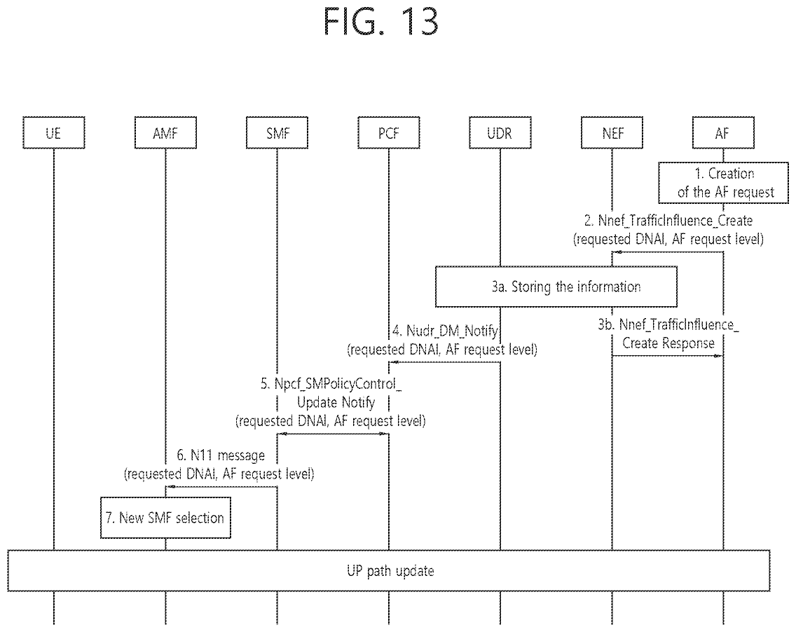

FIG. 13 is an exemplary diagram illustrating a signal flow according to one disclosure of the present specification.

1) Referring to FIG. 13, the AF generates its own request, i.e., the AF request.

2) The AF transmits Nnef_TrafficeInfluence_Create message including information on the AF request. The information on the AF request may include a requested DNAI and AF request level.

3a) The NEF requests to store the information on the AF request in the Unified Data Repository (UDR).

3b) Then, the NEF transmits Nnef_TrafficeInfluence_Create Response message to the AF.

4) The UDR transmits Nudr_DM_Notify message including the AF request information (i.e., including the requested DNAI and AF request level information) to a Policy Control Function (PCF).

5) The PCF exchanges Npcf_SMPolicyControl_UpdateNotify message including the AF request information (i.e., the requested DNAI and AF request level information) with the SMF.

6) The SMF transmits an N11 message including the AF request information (i.e., including the requested DNAI and AF request level information) to the AMF.

7) Then, the AMF selects a new SMF.

Thereafter, the UP path may be updated.

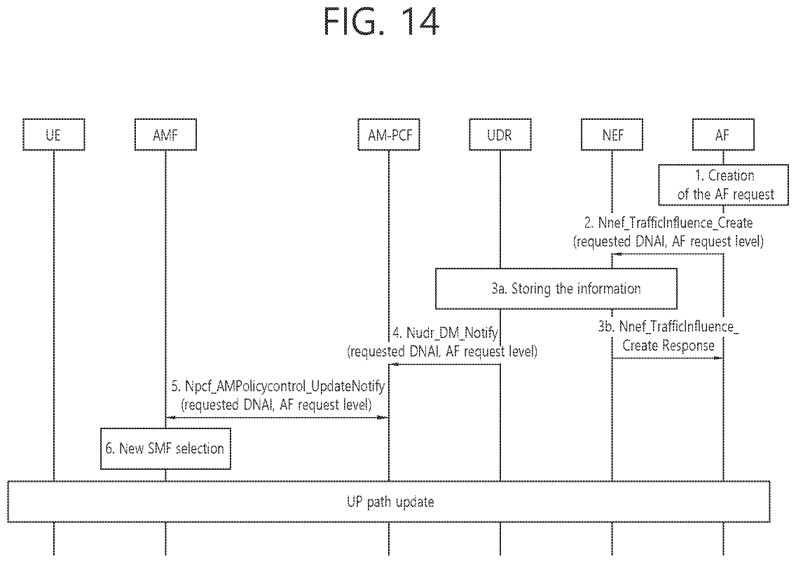

FIG. 14 is an exemplary diagram illustrating a signal flow according to one disclosure of the present specification.

1) Referring to FIG. 14, the AF generates its own request, the AF request. Then, the AF transmits Nnef_TrafficeInfluence_Create message including information on the AF request. The information on the AF request may include a requested DNAI and AF request level.

2) And the AF transmits Nnef_TrafficeInfluence_Create message including the AF request information (i.e., including the requested DNAI and AF request level information).

3a) The NEF requests to store the AF request information (i.e., including the requested DNAI and AF request level information) in the UDR.

3b) Then, the NEF transmits Nnef_TrafficeInfluence_Create Response message to the AF.

4) The UDR transmits a Nudr_DM_Notify message including the AF request information (i.e., including the requested DNAI and AF request level information) to the AM-PCF.

5) The AM-PCF exchanges Npcf_AMPolicyControl_UpdateNotify message including the AF request information (i.e., the requested DNAI and AF request level information) with the AMF.

6) Then, the AMF selects a new SMF.

Thereafter, the UP path may be updated.

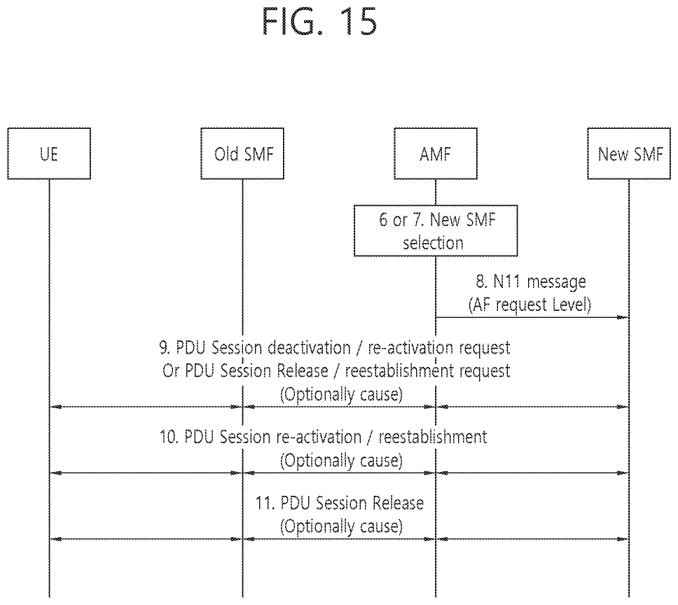

FIG. 15 is an exemplary diagram illustrating in detail a process of updating the UP path after step 7 shown in FIG. 13 and step 6 shown in FIG. 14.

8) The AMF may transmit an N11 message including AF request information (e.g., including AF request level information) to the selected new SMF.

9) Thereafter, a PDU session deactivation or release procedure may be performed. To this end, a PDU session deactivation request message or a PDU session release request message may be transmitted and received.

10) Thereafter, the PDU session re-activation or re-establishment procedure may be performed. To this end, a PDU session re-activation request message or a PDU session re-establishment request message may be transmitted/received.

When the new SMF receives the message, it requests the UPF to change the path of the PDU session.

11) Meanwhile, the UE may perform procedures such as deactivation/release and re-activation/re-establishment of a PDU session based on a cause or direct/indirect information in the received message.

### III. User Interaction (UI)/User Experience (UX) Implementation Examples

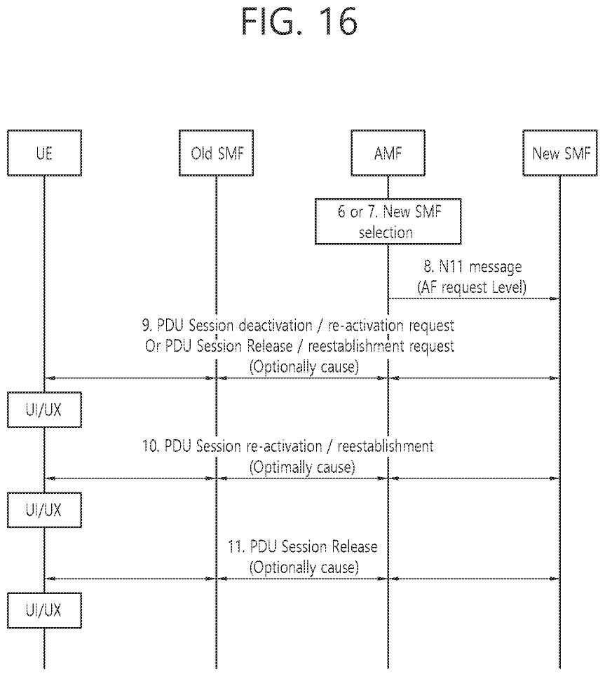

FIG. 16 is a flowchart illustrating a step in which the UE may display a UI/UX screen in a procedure shown in FIG. 15.

After the PDU session deactivation or release procedure is performed in the step 9, the UE may display information informing that a PDU session is scheduled to be created on the screen. The information informing that the PDU session is scheduled to be created may be displayed in the form of a notification window, a specific indication, or a specific icon.

After the step 10 is performed, the UE may display information informing the existence of the PDU session on the screen, while the PDU session is maintained. The information informing the existence of the PDU session may be displayed in the form of a specific indication or a specific icon.

After the step 11 is performed, the UE may inform the user that the PDU session has been released. The release of the PDU session may be displayed in the form of a notification window, an indicator, or an icon to notify the user. Alternatively, an indicator or icon informing the existence of the PDU session may disappear from the screen, so that the user may be notified that the PDU session is released.

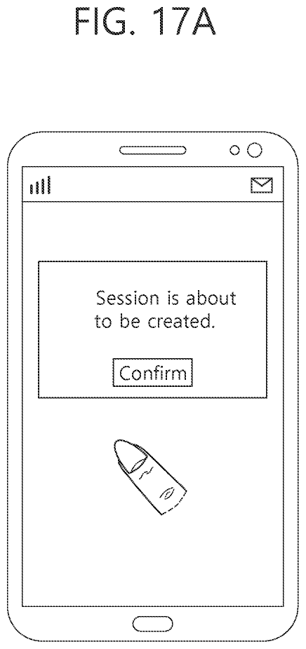

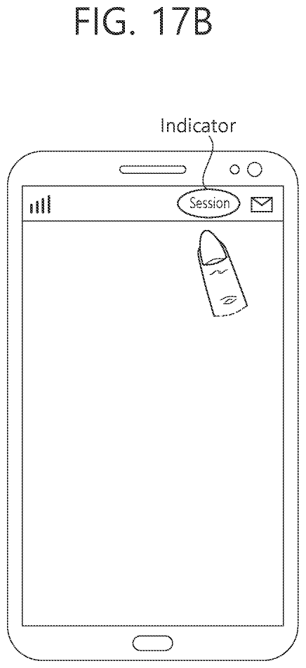

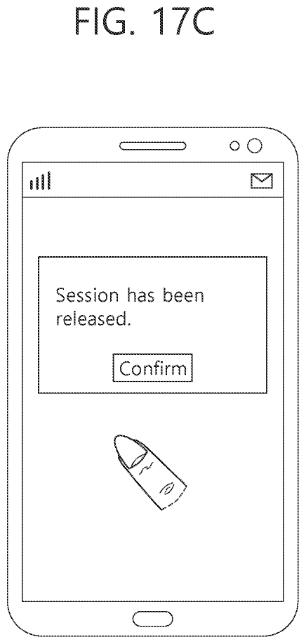

FIG. 17A shows an example of a screen on which information informing that a PDU session is scheduled to be created is displayed.

Referring to FIG. 17A, after the step 9 of FIG. 16 is performed, the UE may display information informing that a PDU session is scheduled to be created on the screen in a notification window.

In the example of FIG. 17A, it is shown to be displayed in the form of a notification window, the information informing that the PDU session is scheduled to be created may be displayed on the screen in the form of an icon or a specific indication.

FIG. 17B shows an example of a screen on which information informing the existence of an established PDU session is displayed.

Referring to FIG. 17B, after the step 10 of FIG. 16 is performed, the UE may display an indicator (or a specific icon) informing the existence of the PDU session on the screen.

The indicator may be displayed with an effect (e.g., blinking color change) according to the AF request level and whether a session is established through the control node and the UPF in a specific region.

On the other hand, the UE may notify the user of the existence of the PDU session by using the background color of the execution screen of the application using the PDU session.

FIG. 17C shows an example of a screen on which information informing that the PDU session has been released is displayed.

Referring to FIG. 17C, after the step 11 is performed, the UE may display a notification window informing that the PDU session has been released on the screen.

Alternatively, the UE may notify the user that the PDU session has been released by disappearing from the screen an indicator (or a specific icon) informing the existence of the PDU session shown in FIG. 17B.

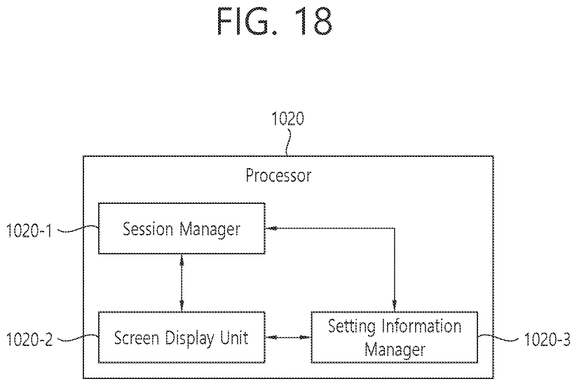

FIG. 18 is an exemplary diagram illustrating an example in which a processor shown in FIG. 12 is configured to display UI/UX.

Referring to FIG. 18 and FIG. 16 together, the first circuit 1020-1 of FIG. 16 may operate as a session manager, the second circuit 1020-2 may operate as a screen display unit, and the third circuit 1020-3 may operate as a setting information manager.

The session manager 1020-1 may perform procedures such as deactivation/release and re-activation/re-establishment of a PDU session based on direct/indirect information received from the network.

The screen display unit 1020-2 may display the screens of FIGS. 17A to 17C.

The setting information manager 1020-3 stores setting information for screen display and session.

### III. Brief Summary of the Disclosures of the Present Specification

The AF may transmit information for using a network node in a specific network topology environment to the core network.

The information transmitted by the AF may include AF request level information. The AF request level may mean a request level negotiated with a service provider to provide a service.

The network control node receiving the information from the AF, e.g., the AMF, selects the SMF as the session management control node, and may directly/indirectly inform the SMF that the selection is based on the AF request.

The UE may perform procedures such as deactivation/release and re-activation/re-establishment of the PDU session based on cause information or direct/indirect information in the received message.

Hereinafter, an apparatus to which the above disclosure of the present specification can be applied will be described.

<Scenario to which the Disclosure of the Present Specification can be Applied>

Although not limited thereto, various descriptions, functions, procedures, suggestions, methods and/or operational flowcharts of the disclosures of the present specification disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

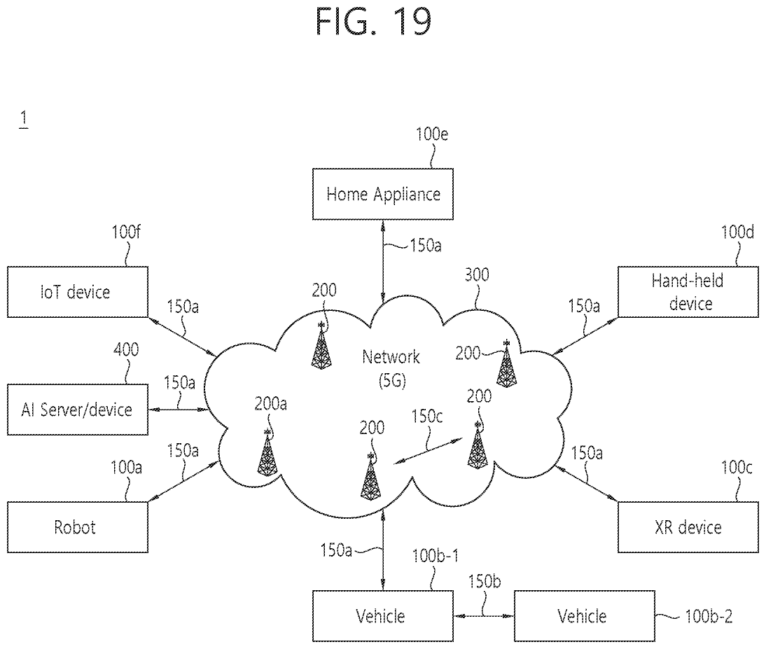

FIG. 19 illustrates a communication system 1 applied to the disclosure of the present specification.

Referring to FIG. 19, the communication system 1 applied to the disclosure of the present specification includes a wireless device, a base station, and a network. Here, the wireless device refers to a device that performs communication using a radio access technology (e.g., 5G New RAT (NR)), Long-Term Evolution (LTE)), and may be referred to as a communication/wireless/5G device. Although not limited thereto, the wireless device may include a robot 100a, a vehicle 100b-1, 100b-2, an eXtended Reality (XR) device 100c, a hand-held device 100d, and a home appliance 100e, an Internet-of-Things (IoT) device 100f, and an AI device/server 400. For example, the vehicle may include a vehicle equipped with a wireless communication function, an autonomous driving vehicle, a vehicle capable of performing inter-vehicle communication, and the like. Here, the vehicle may include an Unmanned Aerial Vehicle (UAV) (e.g., a drone). XR devices include Augmented Reality (AR)/Virtual Reality (VR)/Mixed Reality (MR) devices, and may be implemented in the form of a Head-Mounted Device (HMD), a Head-Up Display (HUD) provided in a vehicle, a television, a smartphone, a computer, a wearable device, a home appliance, a digital signage, a vehicle, a robot, and the like. The hand-held device may include a smartphone, a smart pad, a wearable device (e.g., a smart watch, smart glasses), a computer (e.g., a laptop computer), and the like. Home appliances may include a TV, a refrigerator, a washing machine, and the like. The IoT device may include a sensor, a smart meter, and the like. For example, the base station and the network may be implemented as a wireless device, and the specific wireless device 200a may operate as a base station/network node to other wireless devices.

The wireless devices 100a to 100f may be connected to the network 300 via the base station 200. An Artificial Intelligence (AI) technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the base stations 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-Everything (V2X) communication). The IoT device (e.g., a sensor) may perform direct communication with other IoT devices (e.g., sensors) or other wireless devices 100a to 100f.

Wireless communication/connections 150a, 150b and 150c may be established between wireless device 100a to 100f and base station 200, between base station 200/base station 200. Herein, the wireless communication/connections may be established through various RATs (e.g., 5GNR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the base station 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

In the above, preferred embodiments have been exemplarily described, but the disclosure of the present specification is not limited to such specific embodiments. Therefore, the disclosure of the present specification may be modified, changed, or improved in various forms within the present specification and the scope set forth in the claims.

In the exemplary system described above, the methods are described on the basis of a flowchart as a series of steps or blocks, but are not limited to the order of the steps described, some steps may occur in a different order or concurrent with other steps as described above. In addition, those skilled in the art will understand that the steps shown in the flowchart are not exclusive and that other steps may be included or that one or more steps of the flowchart may be deleted without affecting the scope of rights.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim of the present specification may be combined to be implemented as an apparatus, and the technical features of the method claim of the present specification and the technical features of the apparatus claim of the present specification may be combined and implemented as a method.

1. A method performed by a User Equipment (UE), the method comprising:
transmitting a registration request message to a network;
receiving a registration accept message from the network in response to the registration request message;
transmitting a Protocol Data Unit (PDU) session establishment request message to the network for establishing a PDU session;
receiving a PDU session establishment accept message from the network in response to the PDU session establishment request message;
receiving a first message related to a deactivation procedure or a release procedure of the PDU session, wherein the first message includes a cause and information related to the deactivation procedure or the release procedure of the PDU session;
performing the deactivation procedure or the release procedure of the PDU session based on the cause and the information included in the first message;
receiving a second message related to a reactivation procedure or a reestablishment procedure of the PDU session, wherein the second message includes a cause and information related to the reactivation procedure or the reestablishment procedure of the PDU session; and
performing the reactivation procedure or the reestablishment procedure of the PDU session based on the cause and the information included in the second message.

2. The method of claim 1, wherein the method further comprises, upon performing the deactivation procedure or the release procedure of the PDU session, indicating that the PDU session is deactivated or released.

3. The method of claim 1, wherein the method further comprises, upon performing the deactivation procedure or the release procedure of the PDU session, indicating that the PDU session is scheduled to be established again.

4. The method of claim 1, wherein the method further comprises, upon performing the reactivation procedure or the reestablishment procedure of the PDU session, indicating that the PDU session is reactivated or reestablished.

5-7. (canceled)

8. A chipset mounted on a User Equipment (UE), the chipset comprising:
at least one processor;
at least one memory for storing instructions and operably electrically connectable to the at least one processor,
wherein the instructions, based on being executed by the at least one processor, perform operations comprising:
transmitting a registration request message to a network;
receiving a registration accept message from the network in response to the registration request message;
transmitting a Protocol Data Unit (PDU) session establishment request message to the network for establishing a PDU session;
receiving a PDU session establishment accept message from the network in response to the PDU session establishment request message;
receiving a first message related to a deactivation procedure or a release procedure of the PDU session, wherein the first message includes a cause and information related to the deactivation procedure or the release procedure of the PDU session;
performing the deactivation procedure or the release procedure of the PDU session based on the cause and the information included in the first message;
receiving a second message related to a reactivation procedure or a reestablishment procedure of the PDU session, wherein the second message includes a cause and information related to the reactivation procedure or the reestablishment procedure of the PDU session; and
performing the reactivation procedure or the reestablishment procedure of the PDU session based on the cause and the information included in the second message.

9. The chipset of claim 8, wherein the operations further comprise, upon performing the deactivation procedure or the release procedure of the PDU session, indicating that the PDU session is deactivated or released.

10. The chipset of claim 8, wherein the operations further comprise, upon performing the deactivation procedure or the release procedure of the PDU session, indicating that the PDU session is scheduled to be established again.

11. The chipset of claim 8, wherein the operations further comprise, upon performing the reactivation procedure or the reestablishment procedure of the PDU session, indicating that the PDU session is reactivated or reestablished.

12-14. (canceled)

15. A User Equipment (UE) comprising:
a transceiver;
at least one processor; and
at least one memory for storing instructions and operably electrically connectable to the at least one processor,
wherein the instructions, based on being executed by the at least one processor, perform operations comprising:
transmitting, via the transceiver, a registration request message to a network;
receiving, via the transceiver, a registration accept message from the network in response to the registration request message;
transmitting, via the transceiver, a Protocol Data Unit (PDU) session establishment request message to the network for establishing a PDU session;
receiving, via the transceiver, a PDU session establishment accept message from the network in response to the PDU session establishment request message;
receiving, via the transceiver, a first message related to a deactivation procedure or a release procedure of the PDU session, wherein the first message includes a cause and information related to the deactivation procedure or the release procedure of the PDU session;
performing the deactivation procedure or the release procedure of the PDU session based on the cause and the information included in the first message;
receiving, via the transceiver, a second message related to a reactivation procedure or a reestablishment procedure of the PDU session, wherein the second message includes a cause and information related to the reactivation procedure or the reestablishment procedure of the PDU session; and
performing the reactivation procedure or the reestablishment procedure of the PDU session based on the cause and the information included in the second message.

16. (canceled)
